(19) United States
(12) Patent Application Publication
(10) Pub. No.: US 2008/0041942 A1
(43) Pub. Date: Feb. 21, 2008

(54) Biometric Multi-Purpose Terminal, Payroll and Work Management System and Related Methods

(76) Inventor: Nebil Ben Aissa, Chicago, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/761,938

(22) Filed: Jun. 12, 2007

Related U.S. Application Data
(63) Continuation-in-part of application No. 10/894,498, filed on Jul. 20, 2004, now Pat. No. 7,229,013.
Application No. 10/894,498 is a continuation-in-part of application No. 10/183,767, filed on Jun. 27, 2002, now Pat. No. 6,764,013.
(60) Provisional application No. 60/372,983, filed on Apr. 17, 2002.

(51) Int. Cl. G06K 9/00

(52) U.S. Cl. 235/382

(57) ABSTRACT

A biometric terminal uses a fingerprint reader for authentication of a person. If a match cannot be made, the terminal provides a second opinion by matching other biometric information such as by a voice segment or by a video clip or still picture of the person. The system or terminal may optionally remotely authenticate employees in an interactive voice response (IVR) system, with a second opinion provided by human intervention if the IVR system is unable to confirm a match.

### CROSS-REFERENCE TO RELATED APPLICATIONS

This patent application is a continuation-in-part patent application of U.S. non-provisional patent application Ser. No. 10/894,498, filed on Jul. 20, 2004, which is a continuation-in-part patent application of U.S. non-provisional patent application Ser. No. 10/183,767, filed on Jun. 27, 2002, which in turn is a non-provisional patent application of provisional patent application Ser. No. 60/372,983, filed on Apr. 17, 2002, the rights of priority of which are claimed for this patent application.

### BACKGROUND OF THE INVENTION

This invention relates in general to a biometric multi-purpose terminal, payroll and work management system and related methods, and more particularly, to a biometric multi-purpose terminal that employees may use after authentication with a biometric device, such as a finger print detector to check-in and check-out of work, to receive new work instructions or assignments, to review payroll details, to print a payroll stub, to execute financial transactions, to print a receipt of a financial transaction or to request a payroll advance based upon work hours accrued, to wire transfer funds from a bankcard to another bankcard or bank account, to relay alerts and messages from the work location to back office systems and operational managers, or to order and track equipment at work locations. The invention also relates to systems and methods that utilize such biometric multi-purpose terminals, including deposit of net pay in a bank account associated with each employee's bankcard so that the pay is immediately accessible by each employee.

Most commercial biometric clocks give only test feedback when an employee punches in or punches out. Thus, if a user's fingerprint is not matched, the system displays a text message telling the user that access was denied, or emits an audible tone, such as a high pitch buzzing sound, that can be annoying.

When using biometric fingerprint matching devices for purposes of access control to a secured building or for purposes of employee time and attendance tracking, most systems compare the person's captured and processed fingerprint (usually called “minutiae”) with a stored fingerprint impression, such as a finger print impression which was captured during registration of the employee on the system. Then, based upon the matching threshold, the system makes one of the following two decisions: (1) person is authenticated or (2) person NOT authenticated.

This approach might make sense in many cases. However, it becomes impractical when securing a remote building or when tracking remote employees where a human security guard or a human manager is not present at the location where the employee is being authenticated. For example, if the employee is not authenticated, there may not be another employee available to perform the work expected from the non-authenticated employee. Thus, the better solution may be to permit the employee to perform his/her work despite the lack of authentication and/or to defer the authentication until a human can intervene in the authentication process.

A further problem with remote authentication of employees or persons is that, due to weather changes such as extreme cold, rain or heat, human fingerprints may shrink or dilate. This creates situations where the person using the fingerprint authentication machine may be unable to be authenticated, although they have previously been registered onto the system. This causes frustration on the user's side and calls for a “second opinion” biometric matching methodology.

Biometric time clock devices are used in the marketplace to electronically track employees, especially the clock-in and clock-out times of the employee. However, such devices are often expensive to install and operate, and most such devices require an upfront investment in hardware, software and installation services.

Unfortunately, in remote locations that only require one or two employees, installing such a prior art biometric time clock does not make much economic sense. This is primarily because the cost of installing and operating a remote biometric time clock may actually exceed the profits generated from a remote location with only one or two employees. As a result, many employers, in order to electronically track employees in remote locations, ask their employees to use a telephone timekeeping system to clock-in and clock-out. Such telephone systems may be easy to use and the applicable telephone number can be called from any remote work location. One example of such a telephone timekeeping system is disclosed in U.S. Pat. Nos. 5,646,839 and 5,963,912, both to Katz.

One of the main problems of using a telephone timekeeping systems to track remote employees at remote locations, is that employers do not have the ability to truly confirm the real identity of the remote employee, especially in a low cost way. Such telephone timekeeping solutions primarily consist of an employee dialing into an automated Interactive Voice Response (IVR) system, which interacts with the employee and asks him/her to key in his/her employee number and other work related information by pressing entries into the keypad of the telephone. Some solutions also require tracking of the caller identification number (caller-ID) by looking-up the telephone number which the employee uses to engage the IVR system, and matching it with a pre-registered number in a database. Using caller-ID lookup matching, enables the employer to confirm that the employee is calling from the work location (via caller-ID lookup) instead of calling from home or a non-business location and/or billing for non-worked hours. Although such methods establish that “an” employee called from the work location, such methods still fail to guarantee the identity of the employee.

Thus, although IVR-based telephone timekeeping systems are accurate in identifying the location of the call, such systems still can not eliminate “buddy punching”. Buddy punching is when a buddy who is on time at the work site clocks-in or clocks-out for a late or absent employee. This allows the absent employee to collect full pay for non-worked hours.

Many large industrial companies with easy access to capital and equipment financing have the ability to buy expensive machinery, trucks or equipment then amortize the cost over a 12, 24 or 36 month period. However, smaller companies which can not afford to spend large capital on equipment or do not have access to significant amounts of bank financing, find it almost impossible to perform their work by using business machinery and equipment even though they may be willing to pay more for usage of the machinery, rather than making a buying commitment.

While a few companies offer equipment leasing or rental, such model usually does not truly tie real-time usage of the machinery with the fees paid. Usually, such machinery, trucks or equipment do not have ability to communicate its usage, such as displayed via an odometer or hour meter to a central location. In fact, in most cases, in order to charge the client based on usage of the equipment or machinery, the manufacturer sends a field representative to the remote area where the equipment is being used. The field rep reads the hour meter (or odometer) on the equipment, and then builds a usage report which is then used to bill the client for usage. Such approach is expensive, paper intensive and subject to human error. An easier and simpler solution is needed to offer clients a real-time pay-per-usage billing model for using equipment, machinery or trucks.

The installation process for a time and attendance or an all purpose terminal may be the most costly component of the system. That is, in some instances, the cost of installation may actually exceed the price of the terminal, especially if travel by qualified personnel to a remote location is required. Moreover, configuration of the terminal after installation is not infrequently beyond the capabilities of the customer and requires technical support.

For example, a typical installation procedure may involve sending a trained technician to the site. The technician configures the terminal either via a Local Area Network (LAN) connection or via a phone line connection. The client pays for the technician's time, travel, hotel, travel. The technician sets up the terminal's internet protocol (IP) address, gateway and domain name server (DNS) settings. The technician then connects the time clock to a local area network (LAN) connection which consists of plugging the system's RJ45 cable to the terminal's jack plug, or connecting it to a phone line by plugging an RJ11 jack plug to the system. The technician then configures the time clock for connection to a server. The technician leaves. Another technical person shows up and installs polling software which communicates to the time clock and polls its data. Thereafter, it is the customer's responsibility to make sure that all connections are maintained on a daily basis and that the clock is connected on a daily basis.

One of the problems encountered when servicing low wage, non-English speaking employees is their lack of technology sophistication in using a time and attendance system. Furthermore, due to the distributed nature of the labor environment, other significant issues are encountered, such as that employees move from one remote location to another without much advance notice. In many cases employees quit or give managers little notice that they will be late. As a result, managers have to move their distributed labor around continuously. Thus, the registration of new employees becomes difficult since where they were originally registered is not necessarily where they will end up working. Furthermore, in the case of low wage employee, employee registration and paper-work is usually done at a “hiring office”. Once the employee is hired, has signed his/her employment related paperwork, he/she may be sent to work at the remote location.

Most employers pay their employees weekly, bi-weekly, semi-monthly and sometimes monthly. According to research, the majority of employers pay based on a bi-weekly or semi-monthly basis. This system enables the employee to tap into his or her legitimate pay, but avoid the logistical restrictions imposed by the employer. In fact, by most federal and state laws, once the employee works the hours and the hours are legitimate (such as authenticated by the employee's fingerprint), then the hours are undisputed and become the employer's number one liability. So why does the employee have to wait for their hard earned money? As a result, the employee's cash flow is limited and he/she has to wait for more than two weeks to receive payment for his/her work, not because he/she has not earned the money, but because of limitations on the employer's payroll processing methodology.

When a low wage employee visits a payday loan center, the interest charged to him/her by the alternative financial service store is outrageous. This is because the chances that the person could pay back the full loan is low and the default rates are high. Furthermore, these low wage employees, in most cases, have a low credit scoring and most institutional banks will not service them. As a result, they are desperate to receive any type of financial help at any cost. This type of scenario creates very unfortunate cases of predatory loaning practices which are inhumane.

However, a payday loan service provider may need to charge high fees, when the amount of risk is so high on the loaning customer, and the service provider is stuck with all the risk. Moreover, the service provider may be unable to check on the person's credit (it is typically poor anyway) and is unable to truly service him/her based on historical and concrete information such as credit bureau scoring or reliable employment history.

The main objective of companies that pay employees electronically is to avoid costs associated with mailing and over-nighting paper paychecks and paper payroll stubs. The employer deposits the funds into the employee's bank account, or payroll card, then follows up with an email to the employee containing detail of his or her payroll stub information. However, if the employer has low wage employees that do not have access to the internet or a computer, such employee is suddenly faced with an option to receive electronic payment without knowing his or her payroll stub receipt details. The employee, without access to a computer or the internet, is now forced to take on this solution without ever finding how much was his payroll check gross, net, deductions, FICA or any other deductions and bonuses. There is therefore a need to send an electronic payroll stub to an employee that has no access to a computer or the internet.

In a distributed remote location labor environment, employees are usually unsupervised. As a result, sometimes it takes a few weeks to truly discover what certain remote employees do in such remote locations. However, what if the employee in the remote location decided to remove the all purpose terminal, place it at home, connect it to the internet, clock-in and clock-out of it on a daily basis; and receive pay for hours non-worked at the client site? How would someone find out without having to send a manager to the remote location on a daily basis to police the terminal location and inventory? The present invention addresses these issues.

Some of the major problems when assigning work orders to remote employees are that (1) it is hard to track down employees that are running all over a large building location, (2) a manager needs to be dispatched to the work location in order to communicate the work to the specific employee, and (3) once the work is done, in most cases, there is no feedback mechanism to tie back to the customer and have him/her confirm that the work was actually done to the customer's satisfaction. How would you assign, track and get feedback from a low wage employee that has no mobile hone and might not speak English, and be able to tie his assigned work with customer satisfaction? What if the employee were foreign, how would you communicate the work to them, if the work was requested in English? How could you do it remotely without seeing him/her? The present invention addresses these issues.

Accordingly, there has been a long felt need for an improved biometric terminal which can provide a second opinion on the authentication of an employee or other person. Similarly, there has been a long felt need for a low cost method of confirming the identity of a person for time and attendance at a remote work location. Likewise, there has been a long felt need for an easier and simpler solution for real-time pay-per-usage billing model for using equipment, machinery, trucks, or the like. There has also been a long felt need for a wireless terminal which will self-install and self-configure itself when it is supplied with power.

A general object of the present invention is therefore to provide methods and terminals which utilize a second means, or a second opinion, of authenticating an employee or other person when the primary biometric means is unable to confirm authentication.

Another object of the present invention to provide methods and terminals which utilize video, image and/or voice as a second means of authenticating an employee or other person when the primary biometric means is unable to confirm authentication.

A further object or the present invention is to provide a real-time pay-per-usage billing model for using equipment, machinery, trucks, or the like, by using a remote terminal.

Yet another object of the present invention is to provide a wireless terminal which will self-install and self-configure itself, thereby avoiding costly installation procedures.

Still another object of the present invention is to provide a terminal which may be installed by providing power to the terminal and going to a secure website to activate, set up and preview operation of the terminal.

A still further object of the present invention is to provide a biometric terminal which has a fingerprint reader disposed on the left hand side of the terminal for improved fingerprint matching results.

Another object of the present invention is to provide a biometric terminal which communicates in a plurality of communication protocols to best match the customer's needs.

Yet another object of the present invention is to provide improved means for dealing with employees who are hired and registered at one location and who are later requested to work at another location.

A further object of the present invention is to send an electronic payroll stub to an employee that has no access to a computer or the internet.

### SUMMARY OF THE INVENTION

The present invention has utility in biometric access control of secured buildings and in biometric time and attendance, employee tracking and labor management. The present invention uses for a second opinion methodology where a terminal includes additional inputs to authenticate a person. These additional inputs and outputs may include a high resolution video camera that captures live video and/or still pictures, a high resolution microphone which captures a person's voice and sound waves, and a speaker which directs the person standing in front of the biometric terminal to follow a set of live or pre-recorded instructions.

The terminal captures additional biometric information from the user standing in front of the biometric terminal, such as video, still pictures, or a voice file. These audio and/or video files may then be passed on to the local terminal, to a networked server or to a human (local human or remote human) that uses the second set of information to make a match, or no match decision.

The secondary biometric information which is captured by the terminal may then be processed locally or sent via network (wired network or wireless network) to a networked server. In the case of local processing, the additional information is then processed either in real-time using the local terminal or later processed through the help of a human decision maker, such as a local manager or security guard. If the decision is to make real-time, on-terminal identification matching decisions using the primary and secondary information, then after the primary fingerprint match, the local processor compares the captured secondary information video, still pictures, and/or voice audio files with stored video, still pictures, or voice audio files which were captured during registration and stored on the local terminal. A decision is then made: (1) the user is matched, or (2) the user is not matched.

If the decision is to make later identification matching with the help of a human on the terminal, the local processor presents the captured secondary information video still pictures, and/or voice audio files to the local human operator who previews both sets of primary and secondary captured information. Then the human uses his/her own judgment to make an authentication decision: (1) the user is matched, or (2) the user is not matched. Preferably, the terminal will store and display a report pointing the fact that the identification decision was made with the intervention of a human operator. This report can be displayed on the terminal, or it may be sent via the web for remotely and securely previewing the report, such as at a later time.

In the case of remote network based authentication processing, the additional captured information is sent to a networked server via wired or wireless communication. It is then processed either in real-time using a networked server or later in time via the help of a human decision maker such as a remote manager or a remote security guard. If the decision is to make real-time identification matching decisions on a remotely networked server using the primary and secondary information, then after the primary fingerprint match, the remote server processor compares the captured secondary information video, still pictures, and/or voice audio files with stored video, still pictures, or voice audio files which were captured during registration and stored on the local terminal. Then a decision is made that (1) the user is matched, or (2) the user is not matched.

If the decision is to make later identification matching with the help of a remote human operator connected via a remote server or web, the remote server processor presents the captured secondary information video, still pictures, and/or voice audio files to the human operator who previews both sets of primary and secondary captured information, then uses his/her own judgment to make an authentication decision that (1) the user is matched, or (2) the user is not matched. Preferably, the server will store and display a report pointing the fact that the identification decision was made with the intervention of a human operator. This report may be displayed on the terminal or sent via the web for remotely and securely previewing the report, such as at a later time.

Another aspect of the present invention provides a low cost and simple way to confirm an employee's identity for time and attendance applications via the usage of an Interactive Voice Response (IVR) system and voice matching technology through real-time voice matching processing via a computer, or off-line with the help of a human operator. The person's voice and sound waves are captured, then computer-based voice-matching technology is applied in real-time, or the voice files are placed on a secure web site for a manager to review and confirm at a later time.

Typically, an employee goes to the remote work site, picks up a phone, dials an IVR system by calling a local or long distance number, and then follows the prompt given to him/her by the IVR system. For example, the IVR system may ask him/her to enter their employee number by using the telephone keypad. The IVR system then asks the employee to randomly speak a specific sentence. Such a sentence was spoken by the employee at the time of registration of the employee on the system. The system plays back a sentence which the employee spoke while being registered the first onto the system. The employee speaks the sentence. The system then tries to match the employee's current spoken sentence with the sentence which was previously stored on the system.

If the sentences match, the system accepts the clock-in or clock-out transaction and places it in the employee's timesheet. Thus, the employee will receive full pay for this transaction. If the sentences do not match, the system may ask the employee to try another attempt. This may involve speaking the same sentence again, or speaking an alternative sentence. The number attempts can be 2, 3 or more depending upon the setting selected by the employer.

If there is no match again, then based on the number of attempts, the system captures the voice sentence from the last attempt, and instructs the employee to go ahead and start working. The system then highlights the clock-in or clock-out transaction as a “missed-matched” transaction, and notifies a human operator, such as the employee's manager. The manager, is then prompted to view a secure web report which displays all of the clock-in or clock-out transactions which require his/her attention. When the manager clicks on the actual link, and the voice files from the last attempt are presented to the manager for review. Based upon his/her familiarity with the employee's voice, the employee manager accepts or rejects the actual clock-in or clock-out. If the human operator (manager) approves the employee's identity, the employee receives full pay for the transaction, although the electronic system was unable to match employee identity. Thus, the human operator was needed to give a “second opinion” to the collected lock-in or clock-out transaction. If the human operator (manager) rejects the employee's identity, the employee receives partial (or no) pay for the transaction. Thus, the human operator was needed to give a “second opinion” to the collected clock-in or clock-out transaction.

Typically, in the case of a “buddy punching” situation, the buddy will not speak into the phone when the system asks him/her to say a sentence. As a precaution, the system does not accept blank voice files.

A further aspect of the present invention simplifies usage tracking and establishes a simple pay-per-usage billing model for remote equipment, machinery, truck and other industrial gear. An electronic unlocking mechanism is mounted on the machinery or equipment which permits use only if the operator enters the right code on the unlocking mechanism. The unlocking mechanism has the ability to read the usage level of the machinery, such as an odometer, hour meter, mileage, or other indicia of prior machine usage. An unlocking algorithm is shared between a remote server and the unlocking device. If the operator enters the right unlocking code, the machine operates. If the code is incorrect, the machine will not start.

In accordance with the present invention, the operator can receive the unlocking code from an on-site all purpose Terminal. The operator enters his or her identification information by swiping a magnetic card at the terminal or by placing his or her finger on a fingerprint reader on the terminal, thus authenticating their identity. Then using a general menu provided on a screen of the terminal, the operator enters the usage level (such as mileage) of the machinery. If the correct usage level is entered, the terminal responds with an unlocking code which may be entered on, or transmitted to, the unlocking mechanism to start the machinery. If the usage (mileage) entered on the terminal does not match the real usage level of the machinery, the code received does not match the usage level and the machinery will not be unlocked. The all purpose terminal may also dispense the unlocking mechanism on its own or by being linked in real time to a remote unlocking server that hosts unlocking algorithms and codes.

Alternatively, the operator may also receive an unlocking code by calling a phone number tied to an Interactive Voice Response (IVR) system networked in real-time to a server that hosts unlocking algorithms and codes. The operator could also receive an unlocking code by logging onto a website via a computer or a hand-held phone or PDA device. When the user enters the usage level, the web server responds with an unlocking code. If the correct value of usage, such as mileage or hours operated on the machinery, is entered, a mathematical formula generating unique numbers per unique usage levels is utilized, and the unlocking number is calculated and delivered to the operator. The unlocking number is then copied to the server, to the all purpose terminal and to the unlocking mechanism on the machinery. This way, the same usage level generates the same unlocking code, and a different usage level generates a different unlocking code.

This approach of forcing the operator to enter the exact machinery usage level value on a local terminal or on a remote server in order to unlock the machinery provides continuous true usage values of the remote machinery to the manufacturer or owner of the machinery. This enables the manufacturer to bill the operator based on machinery or equipment usage. This approach provides a simpler and easier way to generate a win-win pay-per-usage billing model without the need to send a field representative to audit remote machinery usage.

In order to facilitate quick and economical installation, the all purpose terminal preferably communicates in plurality of wireless modes. For example, the wireless communication protocols may include GPRS (General Packet Radio Service). GPRS wireless technology is widely used across the world. It may be preferable in remote locations where a wired phone line is not available. WiFi (Wireless Fidelity) may be the best solution for a high speed wireless connection within a client's local office location. However, other communication protocols may be used including Wi-Max (Worldwide Interoperability for Microwave Access), SMS (Short Message Service), MMS (Multi-Media Messaging Service), or simply via cordless 56K wireless connection, where a local 900 MHz cordless modem is connected to a local fax line, and a transceiver on the all purpose terminal connects to the cordless modem.

Another aspect of the present invention is a method of providing for fast and economical installation of a terminal including the steps of giving the terminal a serial number and an internal activation code prior to sale, storing the serial number and activation code in a secure database containing paired serial numbers and activation codes, requesting whether the customer wants to operate the unit in a networked mode or in an off-line non-networked mode, downloading and uploading information directly from the terminal's USB port if operating in the off-line mode, requesting the user to enter a code token in order to activate the terminal if in the networked mode, requesting the customer to enter an activation key, logging onto a secure web site and entering the terminals serial number, and entering the customer's billing and payment information. When the entered information is verified and authenticated, payment is drawn, and the user is presented with the right activation code paired with the terminals serial number. When the customer enters the activation code on the terminal, it becomes operational.

The terminal knows automatically where to communicate, the usage of wireless communication enables it to dial home and send/receive transactions and setup information. Once the device is activated, the customer is being billed for the length of the terminals ongoing communication service. If the customer fails to pay his or her bills, then device is automatically deactivated, and the customer has to go back to the activation step again.

The all-purpose biometric terminal may also be used to enable members of the building maintenance team to control building lighting, fire, security, heating ventilation and air conditioning (HVAC), security and humidity. After using biometric fingerprint identification to authenticate their identity, authorized maintenance personnel will be provided with a menu on the screen of the terminal which will permit changes or modifications to the building's controls or settings.

Still a further aspect of the present invention is to provide a fingerprint reader which is disposed on the left hand side of the terminal. It is believed that about 80 percent of the population is right handed and about 20 percent is left handed. It is therefore preferred to obtain a fingerprint sample from a finger on the left hand, since left hand fingers are typically subject to less use and therefore, less wear. That is, left hand fingers are likely to provide better impressions on the fingerprint reader, which will lead to improved fingerprint matching results.

The present invention further includes methods of sending an order request for cleaning supplies and equipment via the all purpose biometric terminal. The steps include an authorized person such as a manager logging onto the terminal, displaying a menu of additional equipment and supplies (such as cleaning supplies), confirming that the order and the requester are legitimate, and routing the order to a main server. Additional steps may include notifying the next level manager of the order, permitting the next level manager to approve or deny the order made in the field, routing approved orders to an approved supplier of the equipment and/or supplies, and automatically providing the shipping information to the address of the terminal where the order was initiated. When the order is placed, sending a notification to both the ordering manager and his/her next level manager to confirm that the order was placed, sending an automatic notification to the next level manager and the supplier, delivering the supplies to the local, ordering manager get his/her supplies delivered on-site, and attending to payment of the supplier.

Yet another aspect of the present invention is concerned with methods for network-based push and pull style employee profile registration. In these methods, the network is used to allow employee profile, settings, fingerprint impressions, language settings, and the like to travel back and forth from one all purpose terminal to another. This way, an employee can be hired and registered at a hiring office, or location A where all purpose terminal A is installed. Then when the employee tries to log onto all purpose terminal B at another location, his/her profile is passed through the network and loaded remotely, thus allowing him/her to automatically access all purpose terminal B. The employee may then see his/her profile and language setting intact. The process of passing employee profile from one all purpose terminal to another is accomplished either via a pull methodology or a push methodology.

Push methodology to provide employee profile registration over the network to a single or to sets of terminals may include the typical first step of registering an employee on all purpose terminal A, such as capturing employee fingerprint information, training him/her in operation of the terminal, setting up the employee profile, and entering the employee's name, tracking number, social security number, language settings, and the like. Further steps include promptly sending a copy of the employee's profile, fingerprint information and the like from the terminal to the server, selectively allowing the employee access to other terminals such as by making entries on a website, and sending the employee's profile to a new terminal when the employee accesses the new terminal. For example, the information sent to the new terminal may include the employee's fingerprint impression, employee language settings and other employee related information such as messages, social security number and the like. Thus, when the roaming employee revisits the new or remote site, his/her fingerprint is automatically recognized, his/her language settings are displayed and his/her messages are presented to him/her for review and printing.

Pull methodology to provide employee profile registration over the network to a single or to sets of terminals may similarly include the typical first step of registering an employee on all purpose terminal A, such as capturing employee fingerprint information, training him/her in operation of the terminal, setting up the employee profile, entering the employee's name, tracking number, social security number, language settings, and the like, and promptly sending a copy of the employee's profile, fingerprint information and the like from the terminal to the server. However, if the employee is not allowed or pre-qualified to work in location X, and the manager does not have the immediate ability to go to the web to add location X to the employee's profile, then the employee's profile may be pulled from the network to location X.

Representative steps in pulling the employee's profile and related information from the network to location X may include the steps of using the fingerprint reader to authenticate the manager, requesting to “pull” an employee's profile, entering information to identify the employee such as his/her social security number, promptly establishing a connection between the terminal and a network server, and downloading the employee information and settings from the server to the terminal at location X. When done, the employee can login to location X. The employee profile was pulled from the network server to the local terminal, with manager authentication and approval.

This invention ties all the all-purpose terminals to a national network (hub) and shares employee hours worked, and historical payroll stub information (subject to employee approval), so that the employee can receive lower cost pay day loans. This approach is a win-win approach to both the user and the financial service provider. The financial service provider lower the institution's risk by accessing historical information of payroll stub information, and outstanding hours worked, but not paid, thus enabling them to assess the amount of payroll to lean the employee. Likewise, the employee can now feel confident and be able to negotiate a better financing rate now that their profile is part of the system.

The payroll stub information is captured and stored on the server, then is placed in secure repository so it is easily sent to all the all purpose terminals. The information is secured along employee information, fingerprint and profiles. The terminals would also send employee hours worked, and would mark which hours have received payment from the employer and which did not. This gives us the ability to assess the amount of money to loan the employee, so we do not loan the employee money based on hours that were worked and paid. We will only pay the employee advances for hours that were worked but were unpaid by the employer.

The repository is then shared with financial institutions that want to be part of this network. Belonging to the repository of employee payroll stub and outstanding hours network enables them to lower the risk of their loans and increase the amount of volume, since in most economic situations, lowering prices results in increased business volume.

The employee then visits the subscribed financial service location, networked to the repository, and either finds a all purpose terminal, paces his/her fingerprint and receives a lower risk, lower cost payday loan. Or, the local service counter operator, logs into the repository via a secure location and runs a credit history on the employee directly from the repository network. Once done, the employee leaves with the cash, and debt payments are automatically deducted from the employee's next payroll check.

This invention organizes and simplifies the delivery of an electronic stub to an employee that has no access to internet or computers. It offers a multi-media payroll stub delivery platform which considers employee's lack of access to a personal computer (PC) or the internet. The invention builds a payroll repository system which collects payroll stub information from many employers and working entities, then disperses the payroll stub information via a multitude of media platforms. For example via the all purpose terminal, with fingerprint authentication, via electronic mail, via secure computer to computer web services, via a secure connection over a web report, via an Integrated Voice Response (IVR) system and employee authentication using voice matching.

For example, steps of using the IVR system for delivery of an electronic stub may include the employee calling a toll free number linked to an automated IVR system, the employee entering his/her employee number, the system asking the employee to speak a sentence, the employee speaking a sentence, and the system authenticating the employee. If the employee is authenticated, he/she is prompted to listen to his/her payroll stub information. The IVR system reads the information from a payroll stub database storage and speaks the values to the employee. The IVR could speak a summarized version of the payroll stub information or the full document. Employee selects his preference and the IVR system responds as instructed. The employee could also ask the system to send him/her a copy of the payroll stub via fax. The system asks the employee to enter the fax number and asks the employee to re-enter the fax number again, in order to confirm the fax number. This is because no one wants to send his personal payroll stub information to an unknown fax number. The system confirms the fax number and that the fax is being sent immediately. The system advises the employee to stand by the fax receiver. The employee walks to the fax receiver, the payroll stub fax is sent from the IVR system via a bridge from the payroll stub database repository. The employee picks up his or her fax receipt. The employee could also ask to receive his or her payroll stub via SMS (simple Messaging Service). Most low wage employees, although unable to access the internet, might carry a cell phone. SMS is very popular and can be used to deliver payroll stub information to the remote employee. Thus, when the employee is remote and has no access to a computer or email, the present invention enables the employer to offer a payroll stub via multiple media.

The present invention further adds a high resolution camera, caller ID, GPS and IP (Internet Protocol) filtering mechanisms to the all purpose terminal to enable tracking and confirmation of its location. When the terminal is installed, and communicates the first time from its intended location, the system captures and stores a token reflecting its call origination. If the terminal communicates using wireless communication, the system captures its GPS location token, which is its location coordinates (longitude and latitude). If the terminal communicates using a 56K modem dialup connection, the system captures its caller-ID phone number token, which is a phone number. If the terminal communicates using a high speed Local Area Network (LAN) connection, the system captures its IP Filtering token, which is an IP (internet Protocol) address such as 192.168.1.1.

Then, every time the terminal communicates, the server authenticates its connection with the token stored in the communication and verification database. If the unit communicates wirelessly, then the server compares its GPS token with the token stored in the database. If there is a match, the unit continues on communicating. If there is no match, an operator is notified and the communication is aborted. If the unit communicates via 56K dialup modem, then the server compares its dialup caller ID token with the token stored in the database. If there is a match, or the caller-ID falls within a larger pool of caller-ID's, then the unit continues on communicating. If there is no match, an operator is notified, the communication is aborted. If caller ID is blocked, then an operator is notified, but communication is NOT aborted. If the unit communicates via a high speed internet connection, then the server compares its dialup caller ID token with the token stored in the database. If there is a match, or the IP falls within a larger pool of IP's, then the unit continues on communicating. If there is no match, an operator is notified, the communication is aborted. The high resolution camera is then activated every time the location token on the device does not match what is on the database server. This way, the employee that tries to cheat the system has his/her image captured by the camera. This approach confirms the location of the all purpose terminal.

The present invention further enables employers with a distributed labor force and a distributed client base to efficiently dispatch work to multiple employees, track the work and get client feedback using the APM terminal. Typically, the client opens a work ticket request, the work ticket is then automatically translated by the system's built-in translator, and the work order is automatically dispatched to a centralized operator/manager. The operator then, using a set of secure web management tools, assigns the work to a specific employee at a specific work location, where an APM terminal is installed. The work order is then sent to the employee, and the description of the work is matched with his/her language settings. If the employee has Spanish settings, he would receive the work order in Spanish, and so forth. The employee uses his/her fingerprint to authenticate himself/herself, he/she is then presented with the work order. The employee can print the work order and walk around the facility and follow the instructions, or can skip the printing of the tasks, and go right ahead to work.

At the end of the work shift, the employee is prompted by the system and is asked “Did you complete the work?” If the answer is yes, the work order's status becomes “Work completed, need client approval”? If the answer is no, a manager or operator is dispatched to find out why the work was not completed and to potentially help the employee complete his/her work. Once the work order is confirmed done by the employee, an automated Interactive Voice Response (IVR) system is engaged. The IVR system immediately calls the client (using the client's phone number stored in the client's profile database). The client receives an automated call asking him/her to confirm that a specific work order number has been completed to the client's satisfaction. If the answer is Yes, or the client presses ‘1”, then the work is completed with client approval, and the system automatically generates client invoices. If the answer is NO, or the client pushes a “2”, then an operator or manager is automatically dispatched to call the client and resolve the conflict. The work orders could be initially generated from the APM terminal, from the web or from a PDA portable hand-held unit.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a front diagrammatic view of an electronic terminal, with a biometric device suited for reading biometric information from an employee, and that provides a plurality of functions in accordance with the present invention.

FIG. 2A is a diagrammatic view of the electronic terminal illustrated in FIG. 1 in combination with a bar code scanner to monitor an inventory of supplies at a job site.

FIG. 2B is a diagrammatic view of the electronic terminal illustrated in FIG. 1 in combination with a wireless bar code scanner to monitor or track equipment at a job site.

FIG. 3 is a block diagram of the internal structure and functionality of the electronic terminal illustrated in FIGS. 1 and 2A-2B.

FIG. 4 is a simplified block diagram illustrating one embodiment of the present invention in which payroll funds are credited from an account in the employer's bank to the employee's bankcard account for access at an ATM or a point of sale terminal.

FIG. 5 is another simplified block diagram, similar to FIG. 4, illustrating another embodiment in which the employer's bank is also the card-issuing bank.

FIGS. 6A and 6B are a flowchart illustrating the steps employed by the electronic terminal and a computer to authenticate a bankcard number and PIN including the various options available after authentication, such as checking-in or checking-out of work on the electronic terminal illustrated in FIGS. 1-5.

FIG. 7 is block diagram illustrating the entire ATM, payroll and work management system in greater detail than FIGS. 4 and 5.

FIG. 8 is an exploded block diagram of the central processing server array shown in FIGS. 4, 5 and 7.

FIGS. 9A-9G illustrate typical screens that may be used on the display of the electronic terminal shown in FIG. 1 during authentication of an employee or supervisor before he/she can gain access to initiate additional functions or procedures.

FIGS. 10A-10C illustrate typical screens that may be used on the display of the electronic terminal during punching in at work.

FIGS. 11A-11B illustrate typical screens that may be used on the display of the electronic terminal during punching out at work.

FIGS. 12A-12F illustrate the typical screens used on the display of the electronic terminal of FIG. 1 to enable an employee to correct any missed punch-ins.

FIGS. 13A-13G illustrate the typical screens used on the display of the electronic terminal of FIG. 1 to enable an employee to correct any missed punch-outs.

FIGS. 14A-14B illustrate the typical screens used on the display of the electronic terminal of FIG. 1 to review and print any messages.

FIGS. 15A-15D illustrate typical screens that may be used on the display of the electronic terminal of FIG. 1 to review a payroll and to print a pay stub.

FIGS. 16A-16D illustrate typical screens that may be used on the display of the electronic terminal of FIG. 1 to review the balance remaining on the bankcard and to print the balance.

FIGS. 17A-17H illustrate typical screens that may be used on the display of the electronic terminal of FIG. 1 to add or register new employees.

FIGS. 18A-18E illustrate the typical screens used on the display of the electronic terminal of FIG. 1 for a supervisor to register an employee at another work site.

FIGS. 19A-19E illustrate the typical screens used on the display of the electronic terminal of FIG. 1 for a supervisor to approve of, or to edit, the missed punch-out information that was entered by the employee.

FIGS. 20A-20H illustrate the typical screens used on the display of the electronic terminal of FIG. 1 for a supervisor to approve of, or to edit, the missed punch-in information that was entered by the employee.

FIGS. 21A-21F illustrate typical screens that may be used on the display of the electronic terminal of FIG. 1 to deactivate an employee.

FIGS. 22A-22B illustrate typical screens that may be used on the display of the electronic terminal of FIG. 1 to synchronize a newly entered information at the electronic terminal with the system.

FIGS. 23A-23C illustrate typical screens that may be used on the display of the electronic terminal of FIG. 1 to view attendance reports.

FIGS. 24A-24B illustrate typical screens that may be used on the display of the electronic terminal of FIG. 1 to set language preferences.

FIGS. 25A-25D illustrate the typical screens used on the display of the electronic terminal of FIG. 1 by an employee to obtain a payroll advance against currently accrued pay.

FIG. 26 is a flow chart of typical steps involved in interactive messaging, such as between a manager and an employee with the employee sending a reply to the manager from the electronic terminal.

FIG. 27 is a flow chart of typical alerts that the system of the present invention may generate upon monitoring the system or upon employee input into the system.

FIGS. 28A and 28B are a flow chart of typical steps involved in calculating and approving a payroll advance.

FIG. 29 is a flow chart that provides further detail on authentication with the fingerprint reader.

FIG. 30 is a flow chart providing details of printing a payroll stub from an electronic terminal.

FIG. 31 is a front diagrammatic view of the preferred embodiment of an electronic terminal in accordance with the present invention, with a biometric device suited for reading biometric information from an employee and alternative means for providing a second opinion concerning the authentication of a person, and which provides a plurality of other functions in accordance with the present invention.

FIGS. 32A and 32B are flowcharts illustrating the steps employed by the electronic terminal shown in FIG. 30 in providing a second opinion to authenticate an employee or to permit a person to have access to a secure building, respectively.

FIG. 33 is a flowchart illustrating in more detail typical steps which may be employed by the electronic terminal shown in FIG. 30 in providing a second opinion to authenticate an employee or person.

FIGS. 34A and 34B are flowcharts illustrating typical steps which may be employed to remotely authenticate employees in an interactive voice response (IVR) system, with a second opinion provided by human intervention when the IVR system is unable to confirm a match.

### DETAILED DESCRIPTION OF THE INVENTION

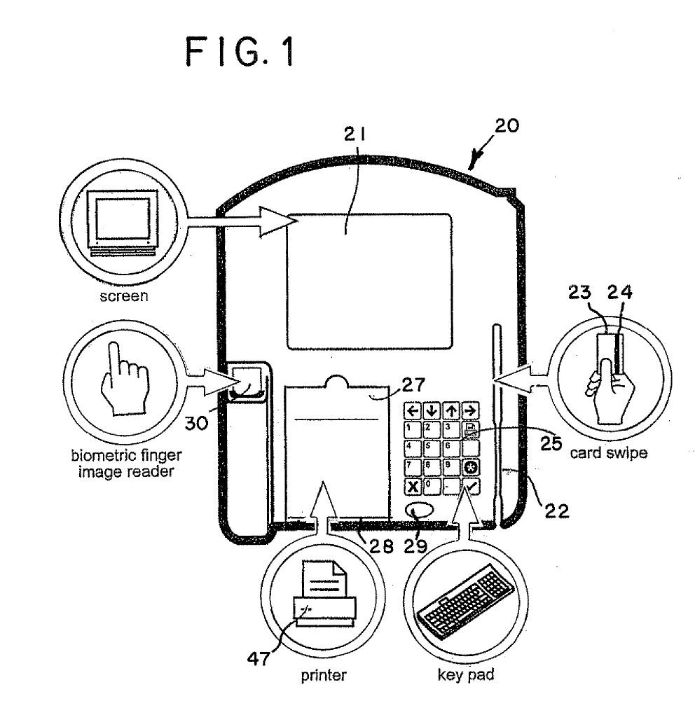

Referring to the Figures, and particularly to FIG. 1, an electronic terminal is generally designated 20. Electronic terminal 20 has ATM, payroll and work management (APW) capability, and may hereinafter also be referred to as an APW terminal 20. Disposed near an upper end of APW terminal 20 is a display screen 21 for displaying information, options, commands, work assignments, messages or the like. Display 21 may be of the liquid crystal display (LCD) type for displaying a plurality of different screens of information, as will be presented in greater detail below. The APW terminals may be located wherever employees usually check-in or check-out of work, such as at the employer's facilities, or at the customer's facilities in those instances where the employees work at the customer's facilities, such as for example, janitorial or cleaning staff.

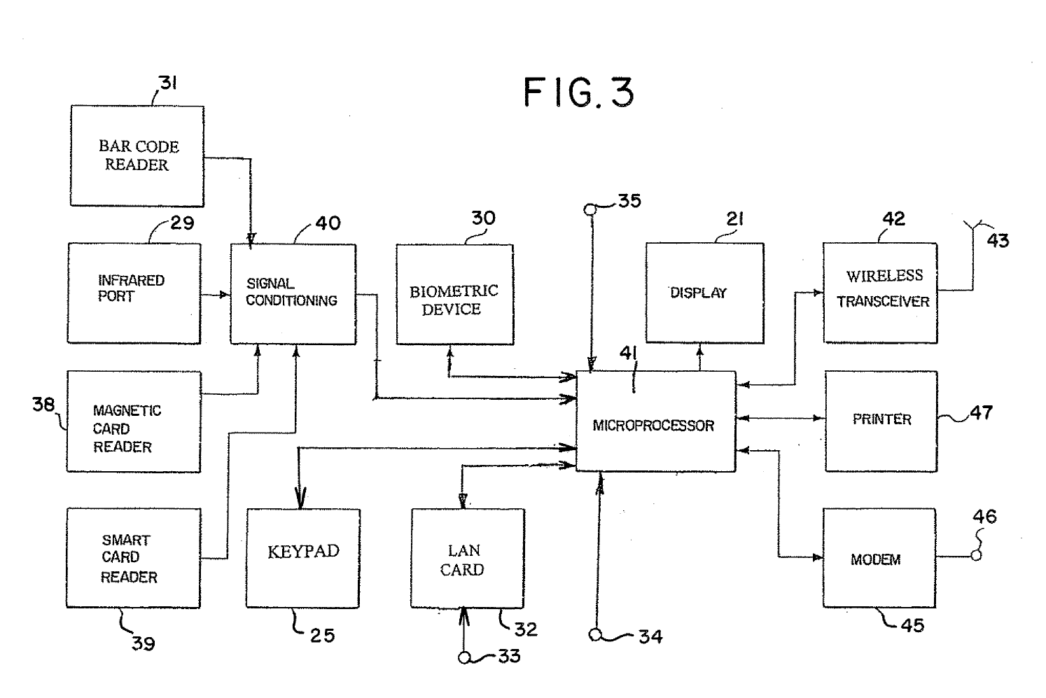

Terminal 20 is equipped with a card reader 38 (FIG. 3) disposed alongside a slot 22 for reading a bankcard 23, a keyboard or keypad 25, a display 21, a printer port 28 and a biometric device 30. Card reader 38 reads the information contained on a magnetic stripe 24 of the bankcard 23, such as a bank account number. For example, card 23 may be a bankcard issued by a bank and the magnetic stripe may have a unique identifying number encoded therein which corresponds to one or more accounts at said bank. Of course, APW terminal 20 could alternatively be equipped to read information from smartcards. Since bankcard 23 is also used in the APW terminal as an ATM, payroll and work management (APW) card, card 23 may hereinafter also be referred to as an APW card.

Keypad 25 contains a plurality of keys for entering numeric information, for scrolling through the information displayed on display 26, for accessing a prior page or the next page, for entering selected information, and the like. For example, in addition to the ten numerals 0-9, keyboard 25 may have four keys; one each for scrolling up, down, right and left. In addition, keyboard 25 may have a key with a period for separating dollar and cent amounts, a key with circular indicia for starting desired functions such as reading a fingerprint on biometric device 30, a key with a printer symbol for printing the current screen appearing on display 21, a star button to continue a desired function, a key with a check mark for approving or responding to specific inquiries or options and a key with an “X” indicia for exiting the present function or for deleting information entered into terminal 20. Examples of the use of the various keys of keyboard 25 will be explained in greater detail below with respect to initiating and executing specific functions that are provided by terminal 20.

Printer port 28 has a printer 47 (FIG. 3) disposed behind an access door 27 and provision for containing a source of paper, such as a roll of paper, behind the access door. When the terminal 20 is instructed to print, the printed paper from a roll is dispensed through the printer port 28 such that the user may tear it off against the forward edge of the port. For example, an authenticated employee may obtain a print-out of a payroll stub relating to the most recent pay period including details about gross pay, deductions and net pay. Other types of printed information from APW terminal 20 may include current work assignments and/or locations, recent activity and balances in bank accounts related to the unique number of the bankcard, and the like. The results of work quality audits may also be made available for printing.

Terminal 20 also preferably includes a biometric device 30, such as a fingerprint reader and comparator (hereinafter fingerprint reader). Due to the unique characteristics of human fingerprints, the fingerprint reader 30 may be used as the preferred form of employee identification, or to supplement the card reader 22 in its reading of the bankcard 23. For example, one of the frequently encountered problems of using the terminal 20 of FIGS. 1-5 is that the employee may forget or lose their bankcard and then be unable to check-in or checkout of work on the terminal 20 if only bankcard access to terminal 20 is permitted. However, with a biometric device 30 provided on terminal 20, the employee will be able to check-in or checkout by applying their finger against the fingerprint reader even if their bankcard is not available at the time of check-in or checkout. This form of identification also provides excellent immunity to the buddy punching problem.

An infrared communications port 29 may be provided, as along the bottom edge of APW terminal 20 in the embodiment shown in FIG. 1, to communicate with other devices that also utilize infrared communication means. For example, a supervisor of employees or a customer of employment services may enter information about new work assignments, or may provide information about previous work assignments that were not completed or that were unsatisfactorily completed. The supervisor or customer may also enter the new work assignments or the feedback on prior work assignments on a portable or laptop personal computer (PC) or a personal digital assistant (PDA) that is also equipped with an infrared communications port. Such information may then be received by the APW terminal and communicated to a computer for processing, storage and/or later retrieval.

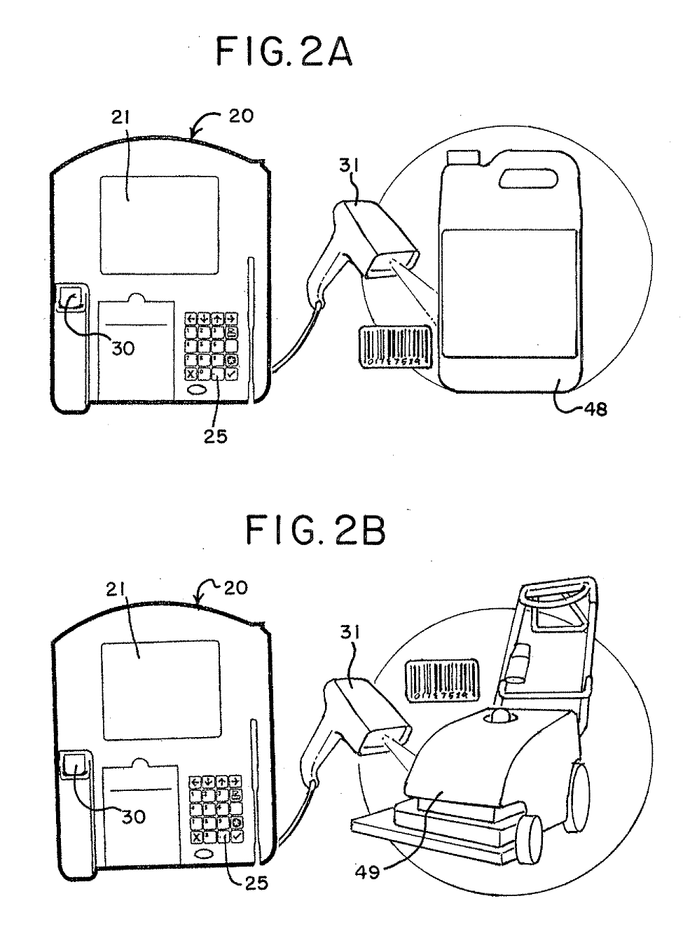

As shown in FIG. 2A, terminal 20 may be equipped with a bar code reader 31, which may be used to read the bar codes on supplies, such as a container 48 of cleaning fluid or the like. Thus, the inventory of supplies may be tracked. Likewise, the bar code reader 31 may be used for convenient ordering or replenishing of supplies. In FIG. 2B, bar code reader 31 is of the wireless type and may be used for monitoring the usage of equipment, such as the floor cleaner 49, or for tracking such equipment.

The internal structure and functionality of APW terminal 20 is illustrated in FIG. 3. As previously described, APW terminal 20 has a magnetic card reader 38 disposed in the card slot 22 to read encoded information from the magnetic stripe 24 disposed on the bankcard 23. Terminal 20 may also be provided with a smartcard reader 39 to read information from a smartcard. As also previously described, terminal 20 has an infrared port 29 to communicate with other devices having infrared ports, such as PCs and PDAs. Information signals from the magnetic card reader 38, the smartcard reader 39, bar code reader 31 and the infrared port 35 are preferably conditioned by signal conditioning circuitry 40 to provide input signals that are compatible with input terminals of a microprocessor 41. The biometric device 30 may interface directly with microprocessor 41. A LAN card 32 also interfaces with microprocessor 41 to provide further connectivity in the APW system 50 via and I/O port 33. Microprocessor 41 also receives inputs from the keypad 25. Microprocessor 41 may be any suitable microprocessor, microcontroller, data processor or the like.

Any of the information provided to APW terminal 20 may be communicated to a computer or database, which may be remotely located. To this end, microprocessor 41 may supply input information to a radio frequency (RF) transceiver 42 for transmission via an antenna 43. The path of RF transmission may be by conventional antenna-to-antenna RF transmission, a microwave link, a satellite link, or the like. Terminal 20 also receives information from a remotely located computer or database via RF transmission in the reverse direction, such as from antenna 43 to RF transceiver 42 to microprocessor 41. Typically, microprocessor 41 will provide some of the received information for display on the display screen 21.

The microprocessor 41 in terminal 20 preferably has sufficient dedicated memory, either internally or externally, to store the unique account numbers of the bankcards and the PINs of the employees that frequently use any particular terminal 20. Authentication of those employees may then be done internally at terminal 20 without having to communicate with a remote computer to access the appropriate account numbers and PINs. However, in such instances, terminal 20 continues to communicate with a remote computer or database to provide the check-in and checkout times for processing of the payroll.

Terminal 20 may also communicate, separately or in tandem with the RF link, via a modem 45. Modem 45 has an output terminal or jack 46 to communicate bi-directionally with a remotely located computer or database either by means of the public switched telephone network (PSTN), by means of the internet, or the like.

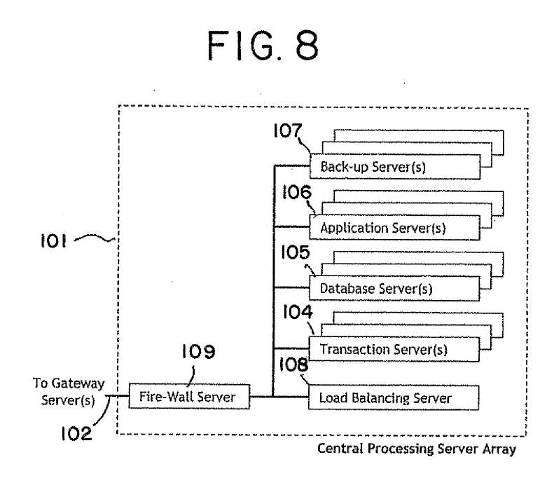

An internal printer 47 may be activated by the printer key on keypad 25 (FIG. 9B) to print information on display screen 21. The printed copy is provided through printer slot 28. Printer 47 may be of the thermal paper type or any other suitable type.

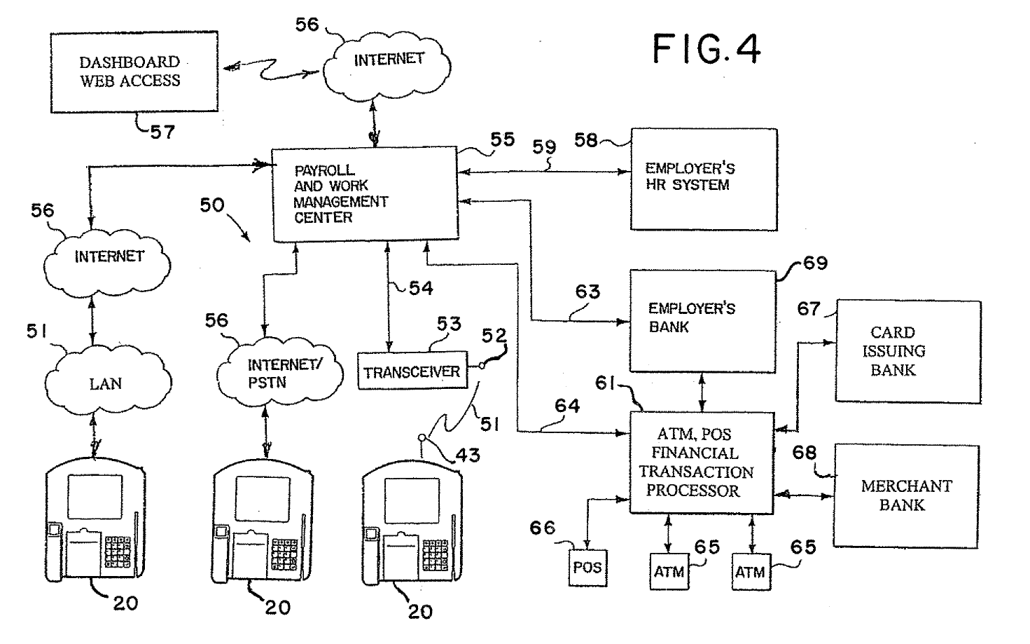

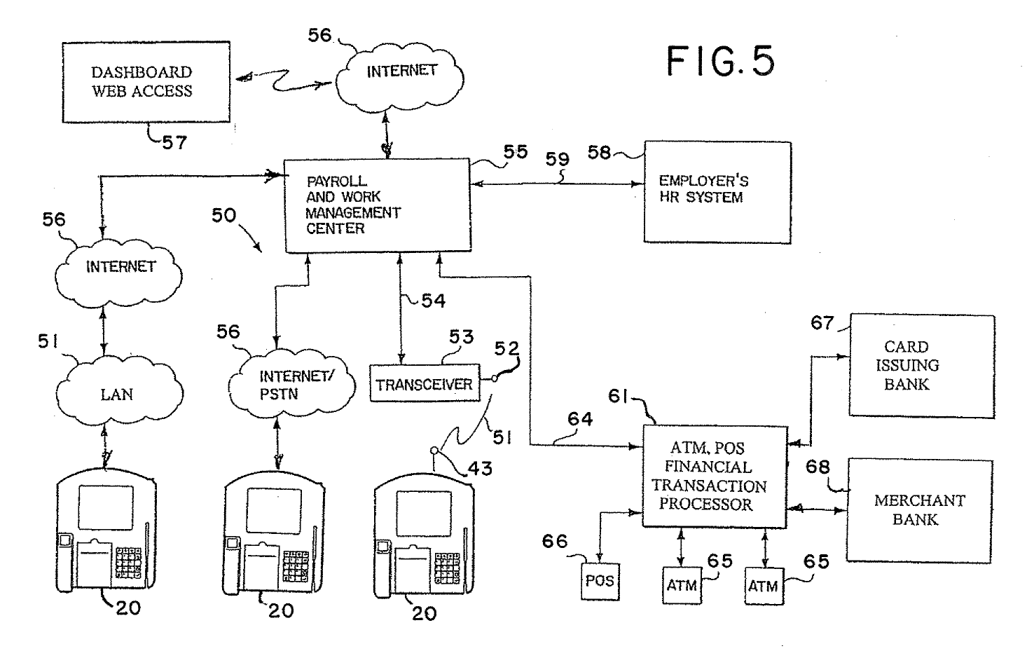

With reference to FIG. 4, there is shown an ATM, payroll and work management (APW) system, generally designated 50. One or more APW terminals 20 are included in the APW system 50. one of the terminals 20 is shown with an antenna 43 to transmit radio waves to the antenna 52 of a transceiver 53, which in turn communicates with a payroll and work management center 55 via one or more lines 54. While antennas 43 and 52 of terminal 20 and transceiver 53, respectively, are shown as external for purposes of the illustration in FIG. 5, it will be appreciated that these antennas 43 and 52 could be internally disposed within the respective terminals. The other terminal 20 is shown communicating with center 55 via the internet or the PSTN 56. Yet another terminal 20 communicates with center 55 via a LAN 51 and the internet 56.

The payroll and work management center 55 has a computer with memory for storing the names of employees, the pay rate for each employee, any deductions from pay for health insurance or the like, the number of the unique bankcard that has been assigned to each employee and the PIN associated with each bankcard. Payroll and work management center 55 may have additional pertinent information concerning each employee, such as a mailing address and a home telephone number. Center 55 previously received such information from the employer's human relations (HR) system 58 via a communication line 59. From time to time as new employees are hired, or when the status of an employee changes, employer's HR system 58 provides updated employee information to the payroll and work management center 55. Dashboard web access 57 enables real-time monitoring of the status the APW system, including information on employees that are registered on the system, the number of employees that have checked into work at any particular site, and the like.

Center 55 also records the time of check-in and the time of checkout for each employee to determine the amount of work time. The pay for each employee is calculated based upon the recorded work time and the pay rate for each employee. These calculations may occur as frequently as directed by the employer, such as each day or each week. Payroll and work management center 55 then advises the employer of the amount of the payroll. Center 55 then performs an electronic funds transfer (EFT) from employer's bank in the amount of the payroll so that each employee's bank account associated with each APW card will be credited in the net amount of pay for that pay period.

Payroll and work management center 55 may advise employer's HR system 58 on line 59, employer's bank 61 on line 63 and/or the ATM, POS financial transaction processor 61 on line 64 of the break-down of the payroll. Each employee with earnings in the respective pay period will have his/her account associated with the bankcard credited with the appropriate amount of net pay. Thereafter, the employee may access his/her available funds, such as by making cash withdrawals at an ATM 65. The APW card may also be used as a debit card against available funds at any point of sale (POS) 66, such as at department stores, grocery stores, gas stations or the like.

FIG. 5 illustrates a payroll and work management system, generally designated 60, similar to the system 50 illustrated in FIG. 4. However, in the system 60, there is no intermediate bank, such as employer's bank 69 in FIG. 5. otherwise, the operation of the system 60 is generally similar to the already described operation of system 50.

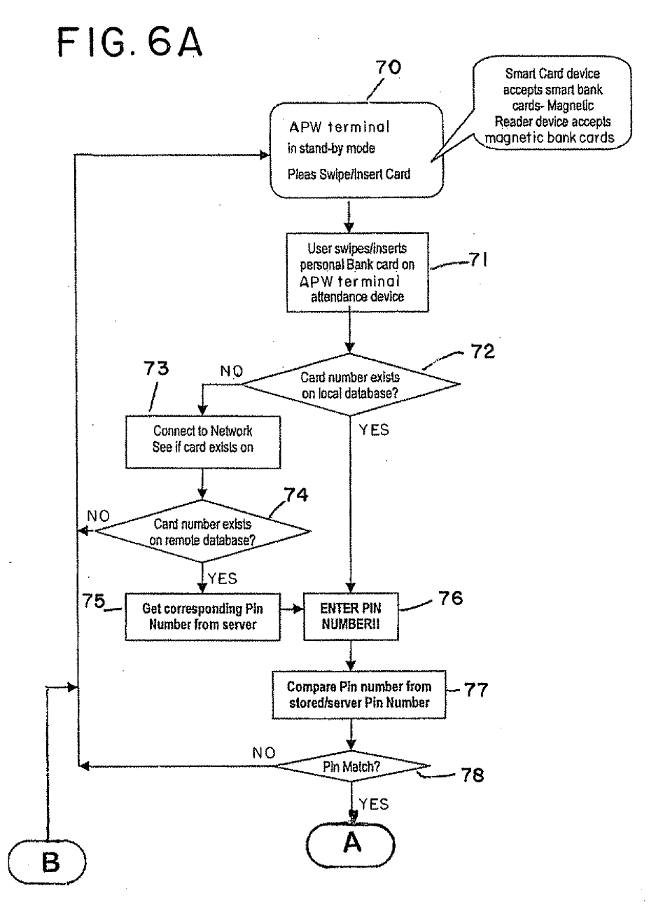

FIGS. 6A and 6B are flowcharts of the functions and communications between one or more APW terminals 20 and the payroll and work management center 55. As seen in block 70, the APW terminal 20 is initially in a stand-by mode and display 21 may display a request, such as “Please Swipe or Insert Card” or use the biometric reader 30. When the user swipes or inserts his/her card or enters a fingerprint on the fingerprint reader 30, the unique account number is read and transmitted, or the fingerprint data is read and transmitted, to the payroll and work management center 55, as indicated in block 71. Center 55 then searches to see if the card number or fingerprint data exists on its local database as shown in decision block 72. If not, center 55 may poll a remote network or database, such as that existing at the employer (block 73) If the card number or fingerprint data exists on a remote database, block 74, the center 55 will also obtain the corresponding PIN from the remote database, block 75. If the card number and PIN or fingerprint data are not available on remote databases, the APW terminal 20 will return to the stand-by mode in block 70.

Assuming that the card number and PIN are available on the local or remote databases, APW terminal 20 requests that the employee enter the PIN at block 76. The entered PIN is then compared to the stored PIN information in block 77. If there is no match, decision block 78 returns the APW terminal 20 to the stand-by mode; block 70. If there is a PIN match at block 78, the authentication procedure is successfully completed and the employee continues to the various options shown in FIG. 6B. The process for handling fingerprint images is described in further detail in FIGS. 9A-9G.

Upon completing authentication, the employee may be presented with four options on the display screen 21, such as sign-in, sign-out, financial transactions and work related functions. The employee then uses the navigation keys to scroll to one of the desired functions displayed on screen 21, or enters the number of the desired option on keypad 25. If sign-in is selected, terminal 20 acknowledges that the employee has signed in at block 80 in FIG. 6B. Block 131 determines if any work assignments or instructions were previously entered for this employee. If so, the work assignments and/or instructions are presented on the display 21 of terminal 20 as indicated at block 132. Since there may be differences in pay for different types of work, the different pay rates are also displayed. The employee may then print out the assignments, instructions and pay rates from the terminal 20. The time of sign-in is then sent to the computer at the payroll center, as indicated in block 82. Alternatively, the computer may simply receive the sign-in information and set the time of sign-in by using its own clock. The APW terminal 20 then exits via block 83, synchronizes its data with that of the computer as shown in block 84 and returns to the stand-by block 70.

If the employee elects to sign-out of work after authentication, as at block 85, the terminal 20 thanks the employee for signing out, as at block 86. The computer then stores the time of sign-out. The computer can then determine the amount of time worked by determining the amount of time between the times of signing in and signing out.

If the employee selects a financial transaction after the authentication procedure, several choices such as shown in blocks 88-92 in FIG. 6B may appear. If APW terminal 20 is equipped for cash transactions, the employee may withdraw cash or deposit money into the bank account associated with the account number encoded on the APW card, as at block 88. If the choice illustrated in block 89 is selected, the employee may see the current balance in the bank account and may review recent account activities, such as within the last month. The employee may also view the last payroll payment credited into his/her account, the gross pay, the deductions from gross pay, the next payroll date, and so forth, as shown in block 90. The employee may also print this information by selecting the print payroll stub option at block 92. The employee may select to transfer funds to another account, such as a checking account, or to request a wire transfer as shown in block 91.

The employee may also select work related functions after authentication of the bankcard and PIN. Blocks 93-97 are reserved for a supervisor or customer to enter information about the performance of the employee that may affect the amount of pay. The employee may view this information, but not make new entries or change the existing information. However, if the employee frequently receives new work assignments, he/she may view the new work assignments or the new work location, as shown in block 98. The new assignments may also be printed out at APW terminal 20, as shown at block 98.

A supervisor or customer may also sign in at terminal 20 as indicated at block 133. A work quality audit may then be uploaded at the infrared port 35 of terminal 20 as previously described, and as indicated at block 134. This is the report that the employee may view at blocks 93-96. The quality audit may result in adjustments to the employee's pay in accordance with prior arrangements or understandings between the employer and employee.

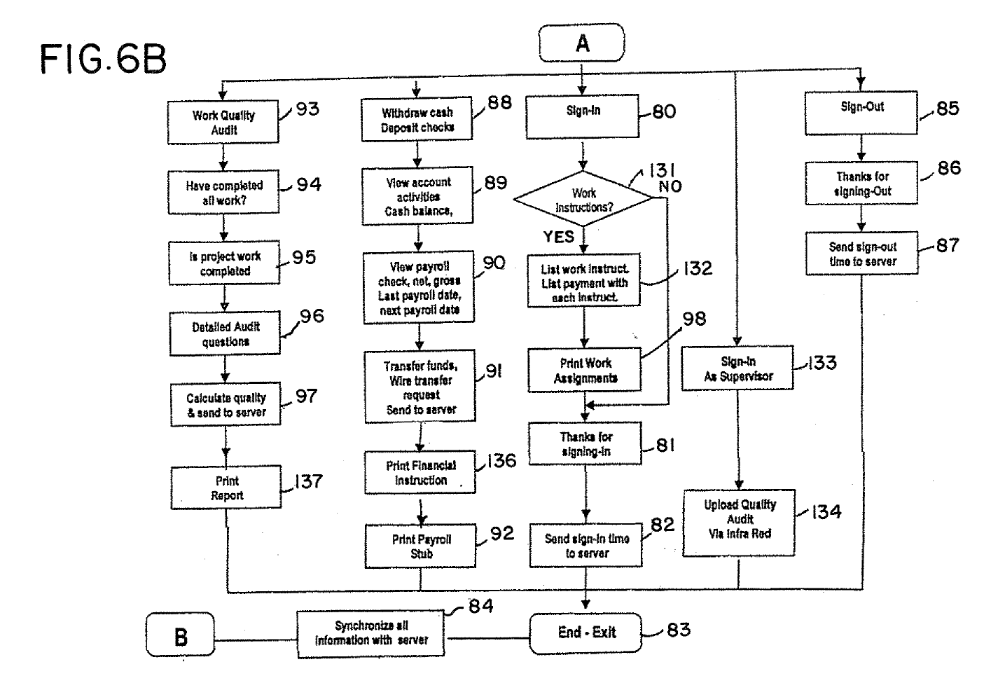

Illustrated in FIG. 7 is a payroll and work management system, generally designated 100. A plurality of APW terminals 20 communicate via links 99, which may be via an internet or PSTN link 56 or a wireless link 51 (FIGS. 4 and 5) to an APW electronic terminal gateway 103. Gateway 103 is equipped with modems and transceivers to receive the communications from the APW terminals 20. Gateway 103 may also be equipped with a conventional firewall to protect a central processing server array 101 from unauthorized access. Information to and from APW terminals 20 is communicated between the array 101 the gateway 103 via lines 102. Gateway 103 may be physically located near array 101 or gateway 103 may be located at an employer's site where it communicates with a plurality of APW terminals 20.

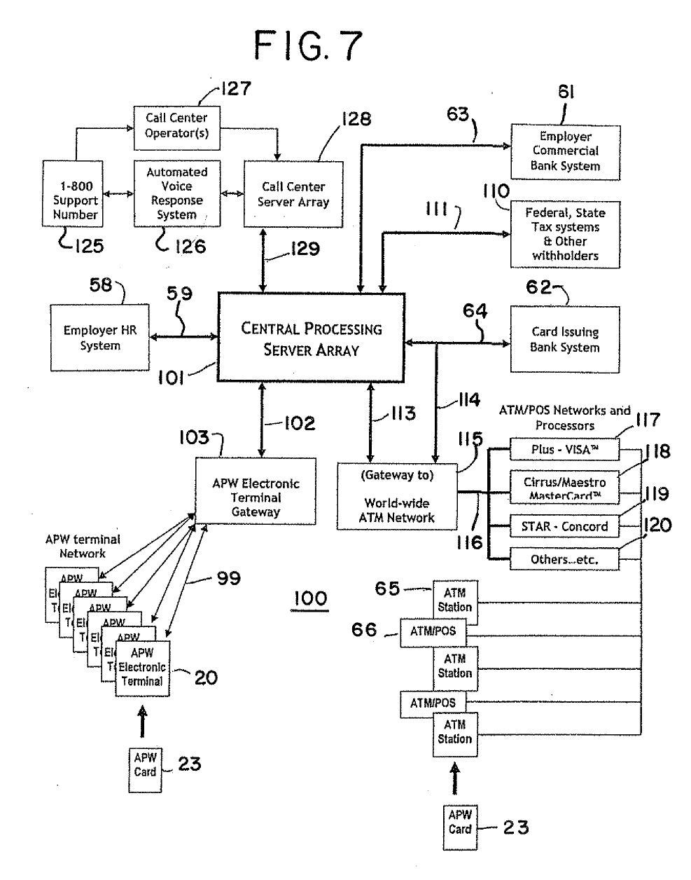

Central processing server array 101 is shown in greater detail in FIG. 8. Array 101 may typically consist of a plurality of servers, such as a plurality of transaction servers 104, a plurality of database servers 105, a plurality of application servers 106, a plurality of back-up servers 107 and a firewall server 109. Of course, the server array 101 can be implemented in a variety of other ways, such as with an Intel™-based computer, a Unix™ based computer, a mainframe computer or the like. Array 101 operates in general as a multi-purpose computer to receive, send, process and store information.

A plurality of server arrays 101 may be distributed in selected locations in a nationwide system, such as in Chicago, New York, Atlanta, Los Angeles, Denver and so forth. The APW terminals 20 will then generally communicate with the nearest server. Preferably, back-up servers are also provided to prevent the loss of stored information and to provide continued processing services in case any one server array becomes non-functional.

The server array 101 operates substantially as already described with reference to FIGS. 4 and 5. Array 101 periodically communicates with the employer's HR system 58 to obtain updated employee information. After calculating a payroll, the array 101 issues electronic fund transfers (EFTs) to transfer funds from the employer's commercial bank 61 to the appropriate federal, state and local taxing authorities 110 for the withheld taxes, FICA and other applicable taxes. The array 101 records all transactions and is able to track the history of all payments.

Server array 101 also issues EFTs upon calculating the payroll from the employer's account at employer's bank 61 through a worldwide ATM network gateway 115. An electronic file containing the amount of the net pay to be credited to each employee's account is sent to the appropriate ATM network processor, such as Plus™ 117, Cirrus™ 118, STAR™ 119 or others 120. Thus, each APW card account is incremented with that employee's net pay. The server array 101 then contacts the appropriate card issuing bank, such as bank 62, to confirm the success of the EFT transfers, as by comparing the total deposit with the sum of all the individual employee net payments. If the EFTs were successful, each employee should have his/her account credited by the appropriate amount of net pay.

ATM networks and processors, such as Cirrus™/Maestro™ 118 owned by MasterCard™, Plus™ 117 owned by VISA™ and Star™ 119 owned by Concord EFS™ are entities that own and link many ATM machines. These entities are in effect service providers for their respective ATM machines. These networks 117-120 have central processing systems that permit funds to be deposited to accounts such as those associated with each employee's APW card. Similarly, these processing systems of the networks 117-120 debit the cardholder's account if cash is withdrawn at an ATM 65 or a purchase is made at a POS 66, such as at a grocery store, gas station or the like. Typically, the PO 66 makes a modem connection with one of the networks and processors 117-120 to process an EFT in the amount of the purchase for credit to the appropriate merchant.

The payroll and work management system 100 also has a call center including a 1-800 support number 125, an automated voice response (AVR) system, one or more call center operators and a call center server array 128. Thus, an employee having difficulty with any APW terminal 20 may call the 1-800 number for help with a transaction, system status, payroll or balance inquiries or the like. Call center operators 127 may have a personal computer to access the central processing server arrays 101 via the call center server array 128 to obtain information about the inquiring employee's account by first logging into central processing server array 101. When using the AVR system 126 from a remote telephone, the inquiring employee uses the matrix of keys on the telephone to access the desired information by following the commands issued by the voice response system in a manner known to the art. The employee logs onto array 101 by entering the bank account number on the APW card and then entering the associated PIN or by use of the fingerprint reader 30, or a combination of both depending upon the desires of the employer. Alternatively, authentication may include the bankcard 23 or the fingerprint reader 30 in combination with an employee ID number.

It will be appreciated that any employee will have considerable reluctance to give even his/her best friend their APW card and PIN. This is because the friend will then be able to access that employee's bank account associated with the account number and the PIN. Even if the friend does not fraudulently withdraw funds from the bank account, the friend will be able to view recent account activity at the APW terminal. Thus, the APW card and PIN operate very effectively to significantly reduce the buddy-punching problem. This may be nearly as effective as any known biometric system. On the other hand, some employers feel that a biometric device, such as fingerprint reader 30 offers better immunity to buddy punching because of the uniqueness of fingerprints.

The APW system also significantly reduces the expenses associated with the conventional activities of processing time sheets and then issuing and distributing checks. Moreover, the APW system readily provides available payroll funds without the expenses attendant to cashing payroll checks at an alternative financial service provider, and provides for more frequent payrolls, such as on a daily basis. It also provides an effective bank account for all employees. Employees may obtain a printed payroll stub at any APW terminal, complete with details on the gross pay, deductions and net pay. Work assignments may also be available for viewing and printing at any APW terminal.

FIGS. 9-24 illustrate screens that may appear on the display the various functions that may be available on terminal 20 for use by employees and supervisors.

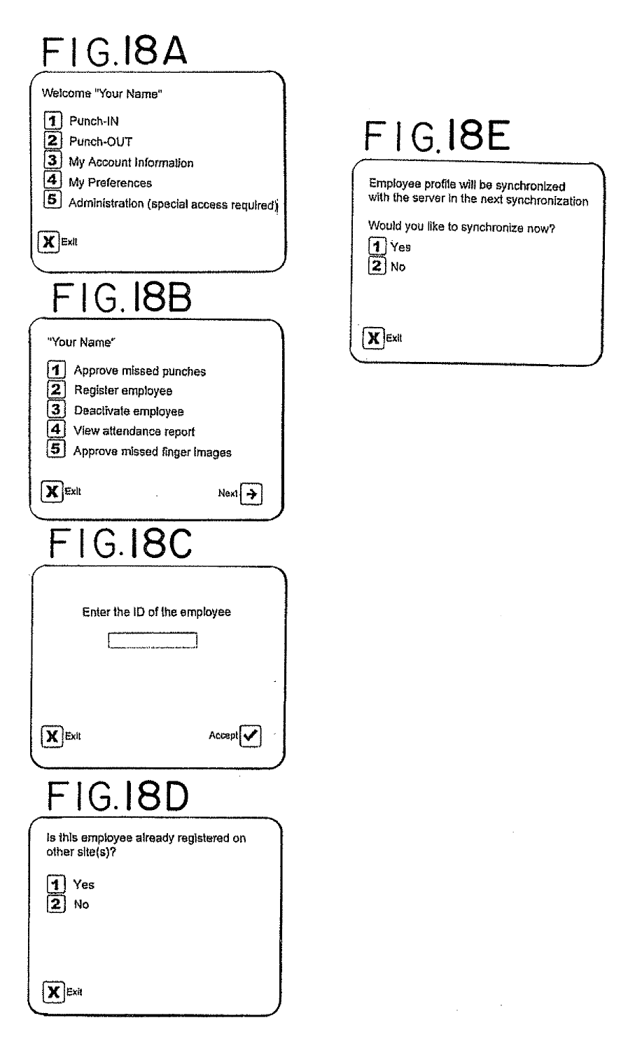

FIGS. 9A-9G illustrate typical screens that may appear on the display 21 of terminal 20 during the authentication procedure, which must be satisfactorily performed prior to obtaining access of any of the other available functions on terminal 20. The initial screen in FIG. 9A instructs the employee to place a finger on the fingerprint reader 30 of terminal 20. Use of a left finger on fingerprint reader 30 is preferable since it keeps the right hand conveniently available for making entries on keyboard 25 or on touch-sensitive screen 21. Of course, if fingerprint reader 30 was disposed on the right side of terminal 20, the opposite would be true, i.e., it would be preferable to read a right finger to keep the left hand available for keyboard or screen entries. When the employee is ready, he/she is instructed to actuate the fingerprint reader by touching the start button on the screen or by actuating the fingerprint reading key on the keyboard 25, as shown in FIG. 9B. Terminal 20 then compares the fingerprint from fingerprint reader 30 with fingerprints scans that were made when the employee was first registered on the APW system. The initial registration procedure, which captures images of the employee's fingerprints, is presented in greater detail below with reference to FIGS. 17A-17H. If the fingerprint reading is matched with a fingerprint on file, such as in a memory of terminal 20 or in the APW system, the next screen to appear on terminal 20 may be the screen in FIG. 9D requesting further information, such as an employee number, which may be a social security number, or requesting that the employee swipe his/her bankcard 23 in the slot of the bankcard reader 22. Note that in this example, the social security number or bankcard information is used to supplement the fingerprint identity, but some employers may be satisfied with only the use of the fingerprint verification or bankcard verification for purposes of check-in. Of course, if only bankcard verification is used for authentication on terminal 20, the employee may also be directed to enter a personal identification number associated with the bankcard number. After entering the social security number or swiping the bankcard, the employee presses the check or accept key on keypad 25 or on screen 21 to continue as shown in FIG. 9D. If only fingerprint identity is used for punching in, the authentication process may skip to the screen of FIG. 9E in which the employee is welcomed by his/her name and provided with various options for further action such as checking in or checking out of work.

However, if terminal 20 cannot match the fingerprint from reader 30 with a corresponding image on file, the screen of FIG. 9C will appear advising of the inability to match the fingerprint. Preferably, there will be a side-by-side comparison of the closest print on file and the currently read image. Orthogonally disposed crosshairs 31 may indicate that the employee placed his/her finger too high or too low, or too far to the left or right, compared with the file image. Preferably, the origin of the crosshairs 31 will coincide near the center of the fingerprint image. Thus, the side-by-side images will assist the employee in attempting to get better centrally located placement of his/her finger on the next reading attempt. The next reading attempt is initiated by the retry button on the screen in FIG. 9C or by again pressing the fingerprint read button on keypad 25 (FIG. 9B). Of course, if the additional employee information of FIG. 9 is available as alternative authentication information, the employee may elect to provide this information instead of continuing the fingerprint reading access to the system. Typically, after two or three unsuccessful attempts of fingerprint reading, the screen of FIG. 9F will appear advising the employee is advised that his/her supervisor will approve of the unmatched fingerprint images at a later time. The screen of FIG. 9G then appears to permit punching in or out of work. Since the employee failed in his/her attempts to properly pass the authentication steps, the screen of FIG. 9G does not provide the employee with access to any accounts associated with the bankcard, preferences or access to administration, as in the screen in FIG. 9E.

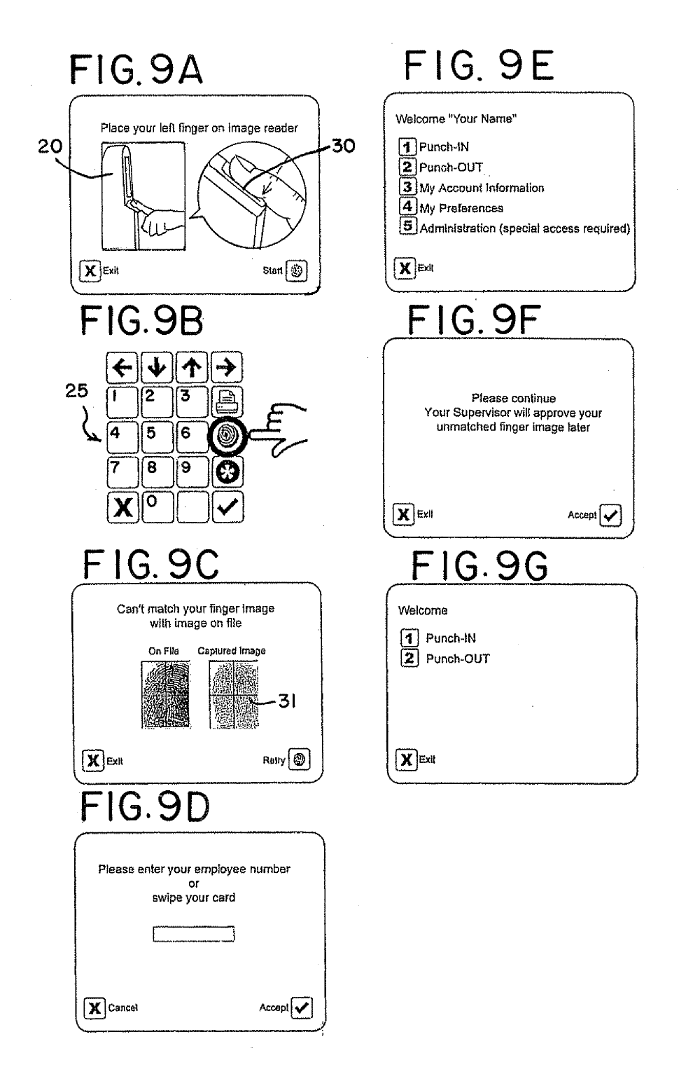

The punch-in procedure on terminal 20 is shown in FIGS. 10A-10C. After successful authentication in FIGS. 9A-9E, the screen of FIG. 9E appeared. The screen in FIG. 9E is the same as the screen in FIG. 10A, which is the beginning of the punch-in procedure. This screen will be called the “main page” since it is the starting point after authentication and since it provides a menu of available functions for the employee to select from, including punch-in. Other available functions that can be selected include punch-out, account information, preferences and administration. These additional functions will be presented in further detail below.

The desired function is selected by touching the desired touch-sensitive button in the screen of FIG. 9E or by entering the associated number 1 on keyboard 25. After selecting to punch-in, the employee may be presented with a menu of job functions, such as that shown on the screen in FIG. 10B. Some employees may have potentially more than one job function and different rates of pay may apply to different job functions. The employee will select the appropriate job function for that day. Note that the employee may also change job functions during the same day by checking out and then rechecking in and entering a new job function for the next portion of the day, or for the remainder of the day. In the example of FIG. 10A, the employee selects the supervisor job function by pressing the numeral 6 on keypad 25 and then pressing the “next” key, which is also the right arrow key on keypad 25. However, pressing the next key before selecting any job functions displayed on the screen shown in FIG. 10B may provide additional job function choices. After selecting a job function in FIG. 10B, the screen in FIG. 10C confirms that the employee has successfully checked in and displays the time of check-in.

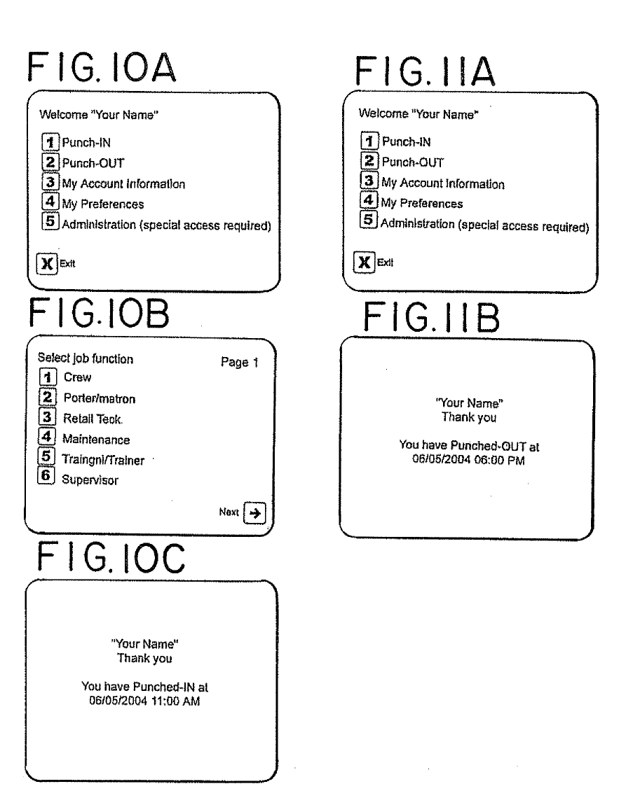

The punch-out procedure is shown in FIGS. 11A and 11B and begins with the main page of FIG. 11A. Punching out is initiated by touching the second listed item in FIG. 11A or by pressing the 2 key on keypad 25. The screen of FIG. 11A appears, which identifies the employee by name and confirms the time and date of punching out.

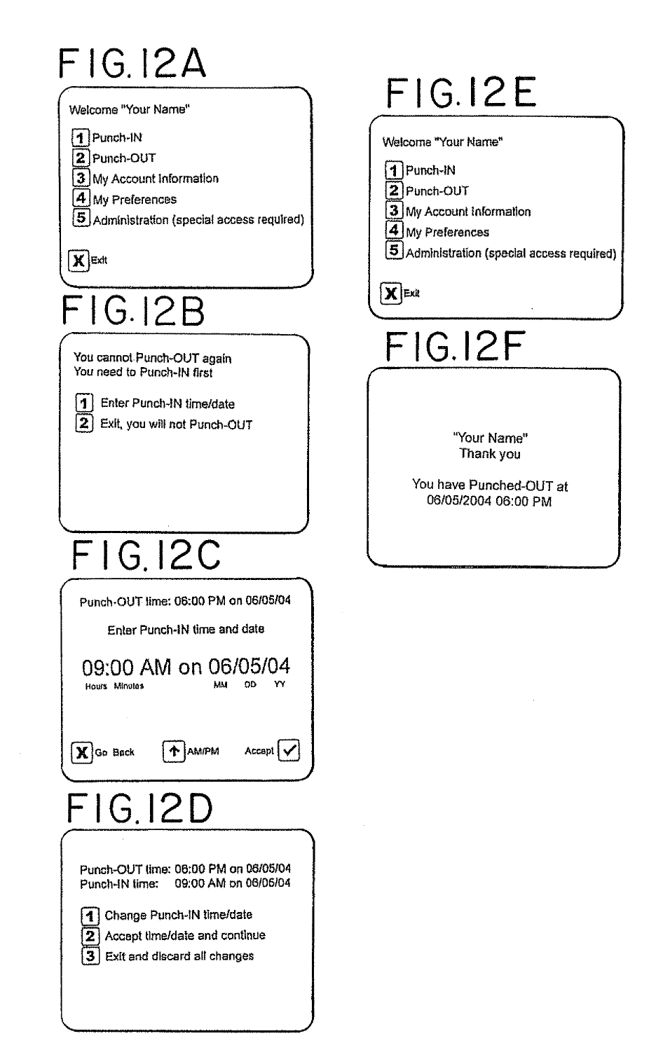

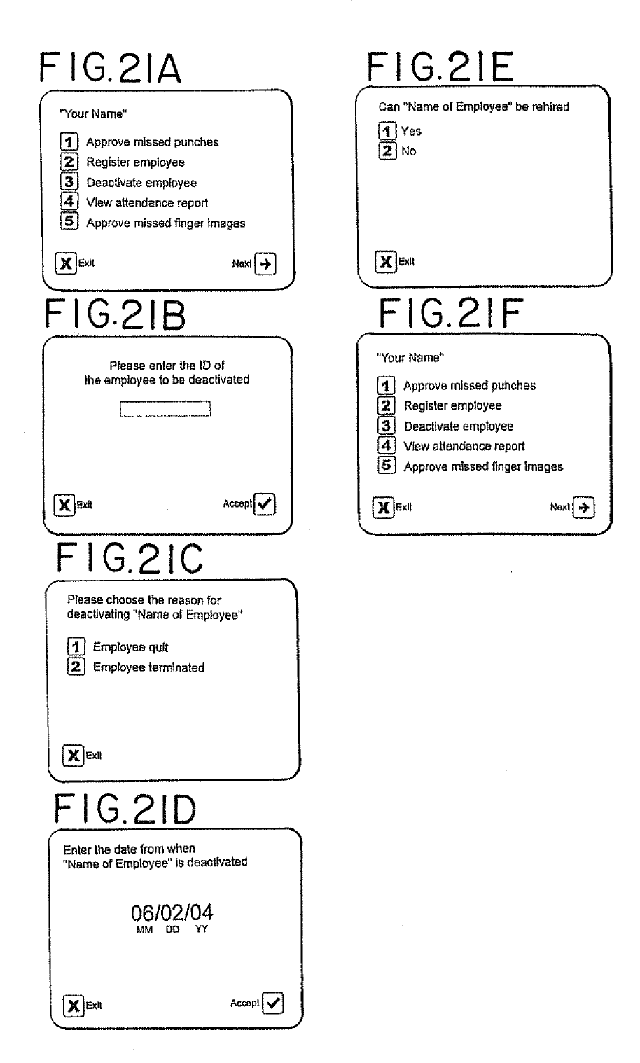

occasionally, an employ may fail to punch-in for work because he/she forgot, was distracted, or the like. The procedure shown in FIGS. 12A-12F enables the employee to supply the missing punch-in time when he/she punches out. In the example of FIGS. 12A-12F, the employee is first responsible for entering the missed punch-in time. The supervisor will later review the employee's entries for the missed punch in and either approve them as entered or edit them in accordance with FIGS. 20A-20H. After authentication and presentation of the main page in FIG. 12A, if the employee tries to punch-out with a missed punch-in, the employee is advised in the screen of FIG. 12B that he/she cannot punch-out again before first punching-in. The screen in FIG. 12B invites the employee to select the first option by pressing the numeral 1 key to manually enter his/her missed punch-in time. The screen of FIG. 12C then appears and enables the employee via keypad 25 to enter the punch-in time and date, as well as the AM/PM designation with the up/down arrow keys. Pressing the accept or check key will save the entered data relating to the missed check-in time. The screen in FIG. 12D then displays the entered punch-in time plus the current punch-out time. Further editing of the data is permitted by pressing the numeral 1 key, acceptance of the data occurs if the numeral 2 key is pressed, or the entered data is discarded if the numeral 3 key is pressed. If key 2 is pressed to accept the times shown, the employee is thanked at the screen of FIG. 12F.

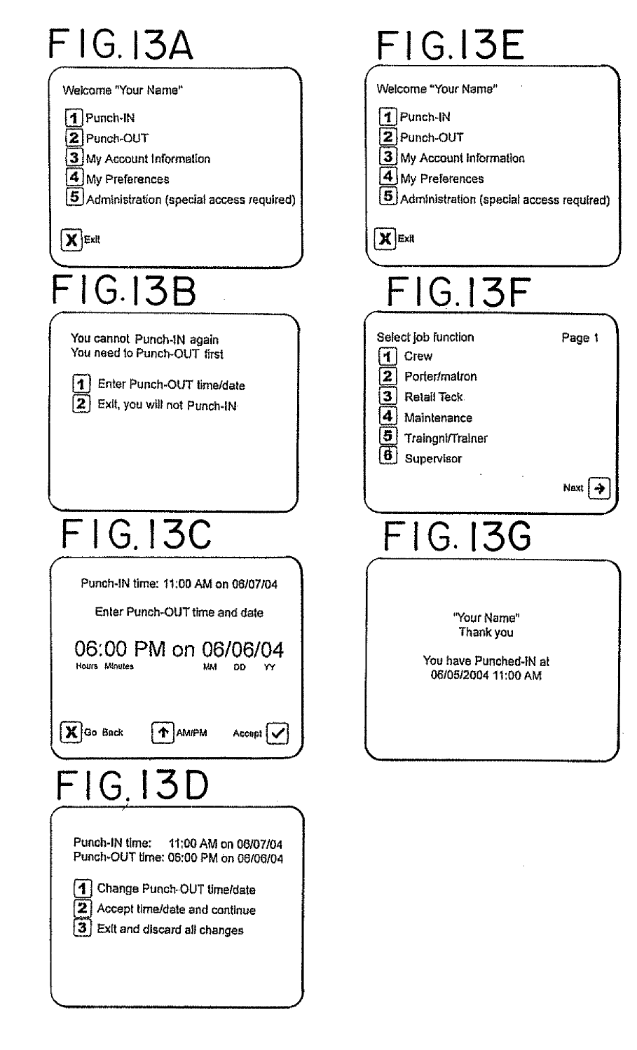

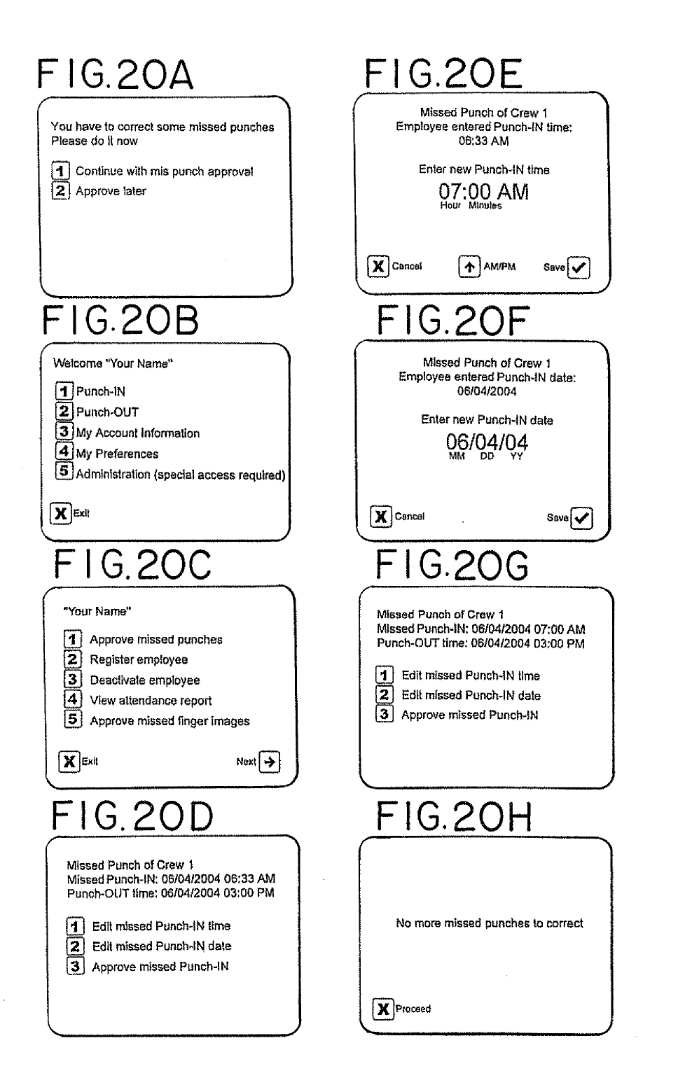

A similar procedure enables the employee to supply any missing punch-out time. This procedure shown in FIGS. 13A-13G enables the employee to supply the missing punch-out time when he/she next attempts to punch-in. In the example of FIGS. 13A-13G, the employee is first responsible for entering the missed punch-out time. The supervisor will later review the employee's entries for the missed punch-out and either approve them as entered or edit them in accordance with FIGS. 19A-19E, as described below. After authentication and presentation of the main page in FIG. 13A, if the employee tries to punch-in with a missed punch-out, the employee is advised in the screen of FIG. 13B that he/she cannot punch-in again before first punching-out. The screen in FIG. 13B invites the employee to select the first option by pressing the numeral 1 key to manually enter his/her missed punch-out time. The screen of FIG. 13C then appears and enables the employee via keypad 25 to enter the missing punch-out time and date, as well as the AM/PM designation with the up/down arrow keys. Pressing the accept or check key will save the entered data relating to the missing punch-out time. The screen in FIG. 13D then displays the entered punch-out time plus the current punch-in time. Further editing of the data is permitted by pressing the numeral 1 key, acceptance of the data occurs if the numeral 2 key is pressed, or the entered data is discarded if the numeral 3 key is pressed. If key 2 is pressed to accept the times shown, the employee is prompted at the screen in FIG. 13F to select the appropriate job function upon checking-in. The employee is then thanked at the screen of FIG. 13G, including confirmation of the current check-in time.

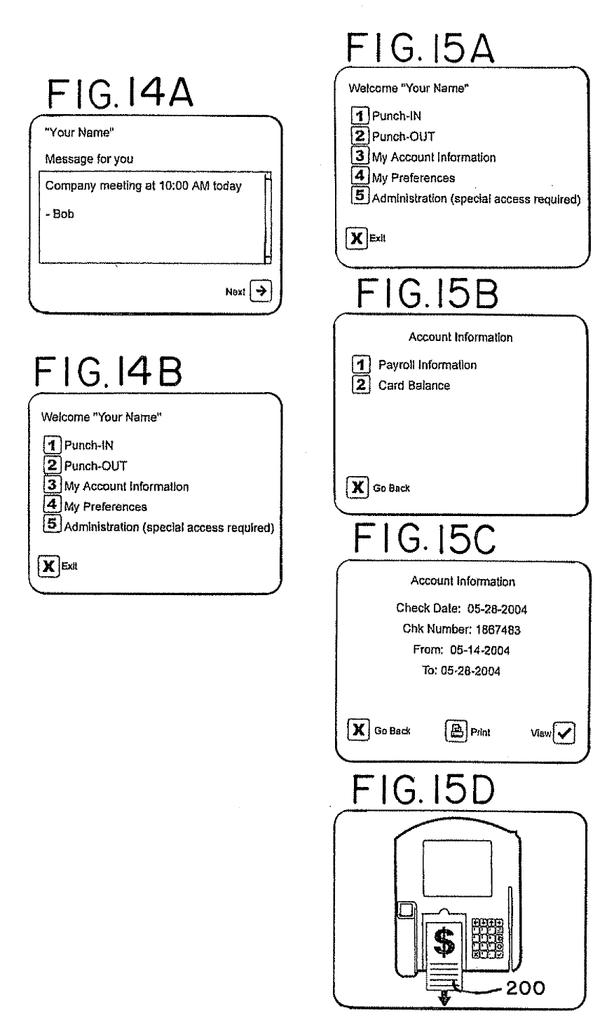

FIGS. 14A-B are concerned with reviewing and printing any messages. After employee authentication, any message, such as that displayed in FIG. 14A will appear before the main screen appears. The content of the messages can vary significantly, such as that of a scheduled meeting in FIG. 14A, the need to call someone, a changed work assignment, a changed work location, an additional work assignment, a request to accept a different job function for the day, or the like. The employee may press the print key shown on keypad 25 in FIG. 9B (above the fingerprint activation key) to print a copy of the message. Pressing of the next or right arrow key in FIG. 14A will take the employee to the main screen of FIG. 14B. The employee can then select one of the main menu options or exit the terminal 20.

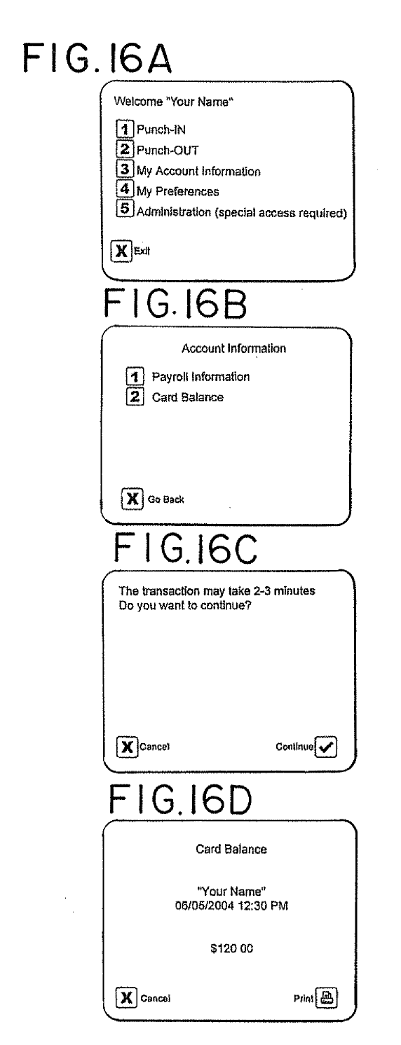

FIGS. 15A-D show the steps utilized to review payroll information and to print a payroll stub. After system authentication of the employee, the employee enters the numeral 3 key on the keypad in FIG. 15A to access My Account Information. In FIG. 15B, the employee enters the numeral 1 key to access payroll information. The screen in FIG. 15C will appear showing the check reference number, the pay period and the date of the check or payment to the bankcard. If the print key on keypad 25 is pressed, a payroll stub 200 will be printed from terminal 20 as shown in FIG. 15D.

A universal payroll stub format should be suitable to send, receive, display, deliver and print any type of payroll stub over the following media:
The All purpose ATM device
Over the web
Over the phone via an Integrated Voice Response (IVR) system
   One of the main problems in printing a universal stub is the ability to send, receive and print multiple employees and multiple employer payroll information. For example some employees might be enrolled in a 401K program, while others have to pay alimony. Some employers offer a payroll deduction credit for a specific health or benefit program while others don't. We've developed an infrastructure and communication methodology which handles, delivers, displays and prints, any type of payroll stub information. Our universal payroll stub infrastructure id designed using the following format:
Prior to sending and/or receiving a payroll stub to a device, web or IVR system, the employer must send us a template header record infrastructure detailing the general display of the pay stub. Such a template would contain records such as (1) GROSS PAY, (2) DEDUCTIONS, (3) TAXES (4) NET INCOME. From now on, any record received from the employer would be classified using the employer's record schema
Then, every payroll stub record must contain the point to the employer's template schema file. For example to show that Joe Crew has $1,000 in Wages for this pay period, and $5,000 in Wages Year-To-Date (YTD); and that he received $100 in bonus pay for this pay period and $300 in total YTD bonus pay. The employer would send the information in the following structure:
   “1”, “Wages”, 1000, 5000
   “1”, “Bonus Pay”, 100, 300

This automatically generates payroll stub information in the following format:

GROSS PAY

| | Current | Year to Date |
|---|---|---|
| Wages | $1,000.00 | $5,000.00 |
| Bonus Pay | $100.00 | $300.00 |

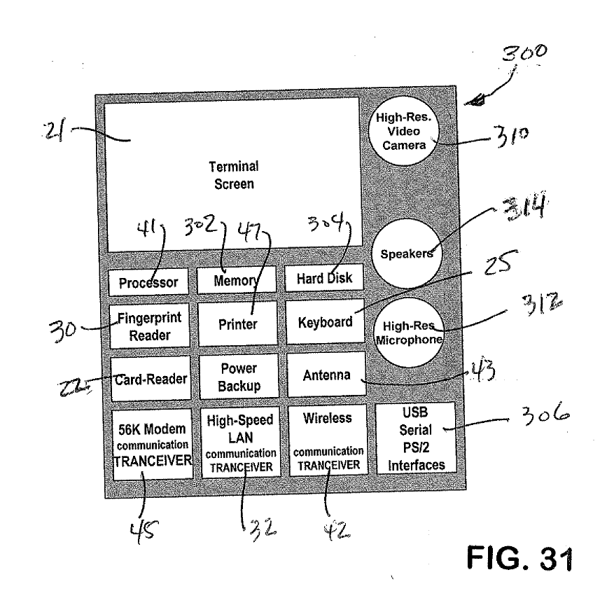

According to many state labor regulations, employer must give en employee a physical printout of his/her payroll stub on pay day at the location of work. Although many employers offer their employees direct deposit and give them access to electronic payroll stubs via secure internet, this approach is not feasible for a low wage employee, who usually does not have access to a PC or the internet. As a result, from an employer's perspective electronic payroll to a low wage employee is a losing proposition. This is because, even though, the employer is saving cost from mailing a physical paper check to a remote low wage employee, the employer still has to mail a physical paper pay stub to the employee in order to comply with state labor regulations. If this is the case, then the employer might as well send a paper paycheck with a paper pay stub and avoid the hassles of integrating electronic payroll with mailing a paper paystub to all low wage labor locations. Using the all purpose biometric device, upon accessing the system, and if today is payday, the employee is prompted to print his/her paystub. See, the flow chart of FIG. 30 for further details. This approach gives employers compliance with state and federal labor laws, this is because:
a. Employee was paid on pay day via electronic payroll deposit (on payroll card)
b. Employee was presented with a payroll stub at work location. Employer has a record that the employee decided to either print or not print his/her payroll stub on payday, at the work location.

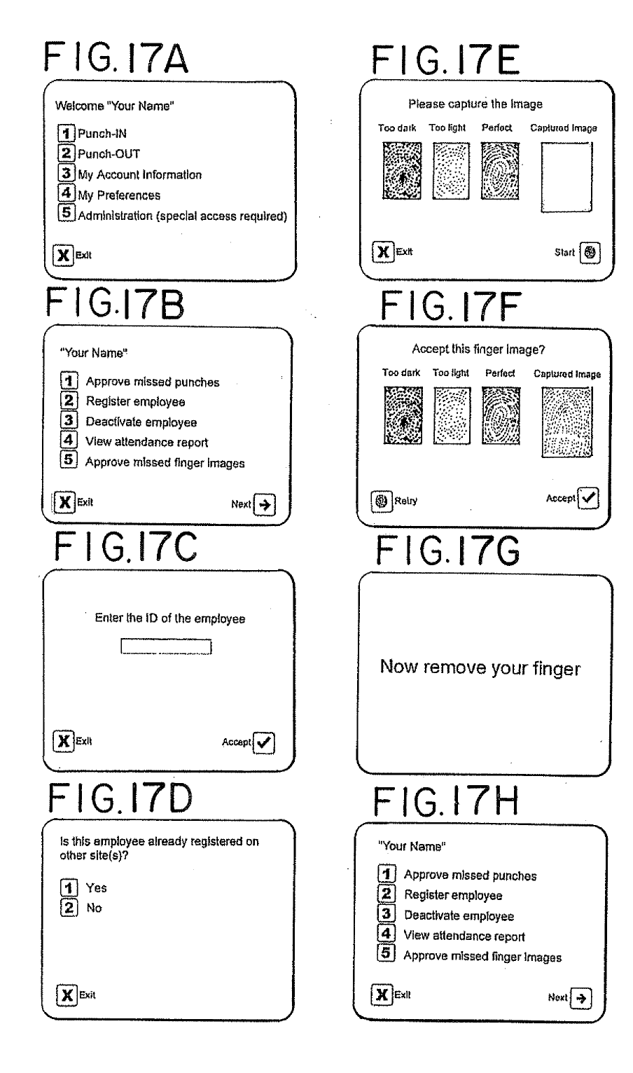

FIGS. 16A-D illustrate the steps used for viewing and printing the current balance remaining on the bankcard 23. After correctly authenticating with the system, the employee is welcomed at the main screen shown in FIG. 16A. If the employee selects the My Account Information by pressing the numeral 3 key on keypad 25. the screen shown in FIG. 16B will then appear. To review the balance on the bankcard, the employee presses the numeral 2 key on the keypad to select “Card Balance”. The employee is advised in FIG. 16C that there may be a short delay in retrieving the requested information and he/she is requested to press the check button on the keypad to continue. If the employee elects to continue, a short time later, a screen similar to that in FIG. 16D appears, advising the employee of the balance then remaining on the bankcard. The employee may then print the balance in the bankcard account by pressing the printer key on the keypad 25 (FIG. 9B). Whether the screen of FIG. 14D is printed or not, if the employee presses the cancel button on the keypad, the screen returns the Account Information screen of FIG. 16B. Entering the go back or cancel button again will return the employee to the main screen of FIG. 16A, where the employee may select additional options, including punch-in and punch-out or selecting exit. If the employee does not return to the main screen of FIG. 16A, the terminal 20 will automatically revert to the starting screen after a predetermined time of inactivity.

FIGS. 17A-17H illustrate the procedure for registering a new employee, including obtaining useable fingerprint images from the new employee with the fingerprint reader 30 of terminal 20 for later use in the authentication procedures of FIGS. 9A-9G, above. This entails providing about three images of a finger, such as the left index finger, to the system for subsequent comparisons during future uses of the terminal 20. In FIG. 17A, a supervisor selects the Administration function by pressing the 5 key on keypad 25. In FIG. 17B, the supervisor selects the Register Employee function by pressing the 2 key on keypad 25. In the screen of FIG. 17C, the identity of the new employee, such as an account number associated with bankcard 23, a social security number, or other employee number is entered via keypad 25. Such an employee ID number will be associated with fingerprint images by the APW system and/or terminal 20 in subsequent authentication procedures. When the employee ID number is entered and the check or accept box is actuated, the screen of FIG. 17D appears asking if the new employee is already registered on a different site or location. If so, fingerprint images already in the system may be used at the new work location. If not, the procedure continues to the screen of FIG. 17E.

In FIG. 17E, the new employee is then requested to capture a fingerprint image by placing a finger on the fingerprint reader 30, as in FIG. 9A. In the example of FIGS. 17A-17H, the new employee may a supervisor since supervisors must also register with the system in order to gain access thereto. Pressing of the fingerprint reader button captures the fingerprint image and displays it on the screen shown in FIG. 17F. The captured image is compared to acceptable and unacceptable images and the employee is prompted to decide whether to accept the captured image as a reference image for future comparison efforts during authentication procedures. As seen in FIG. 17F, the perfect image is one that is not too dark, nor too light, and which displays sufficient fingerprint detail. Preferably, the image of the fingerprint captures the whorl, and has differentiated ridge and valley areas with distinct lines of relatively high contrast. A poor image may be due to a dirty finger, placing the finger too high or too low on the reader 30, or using too much or too little pressure against the reader.

While reference is frequently made to the employee in these registration steps, it will be understood that a supervisor is typically assisting the new employee and that the supervisor may be deciding whether a captured image is suitable for saving for future reference purposes. If the first captured image is accepted by pressing the accept button on the screen or the accept key on keypad 25, terminal 20 may then request that additional images of the fingerprint be entered and captured for future comparison purposes. When the appropriate number of images has been captured, the employee is instructed to remove his/her finger from the fingerprint reader 30 in FIG. 17G. Preferably, about three fingerprint images may be captured for this purpose. In FIG. 17H, the terminal then reverts to the main supervisory page.

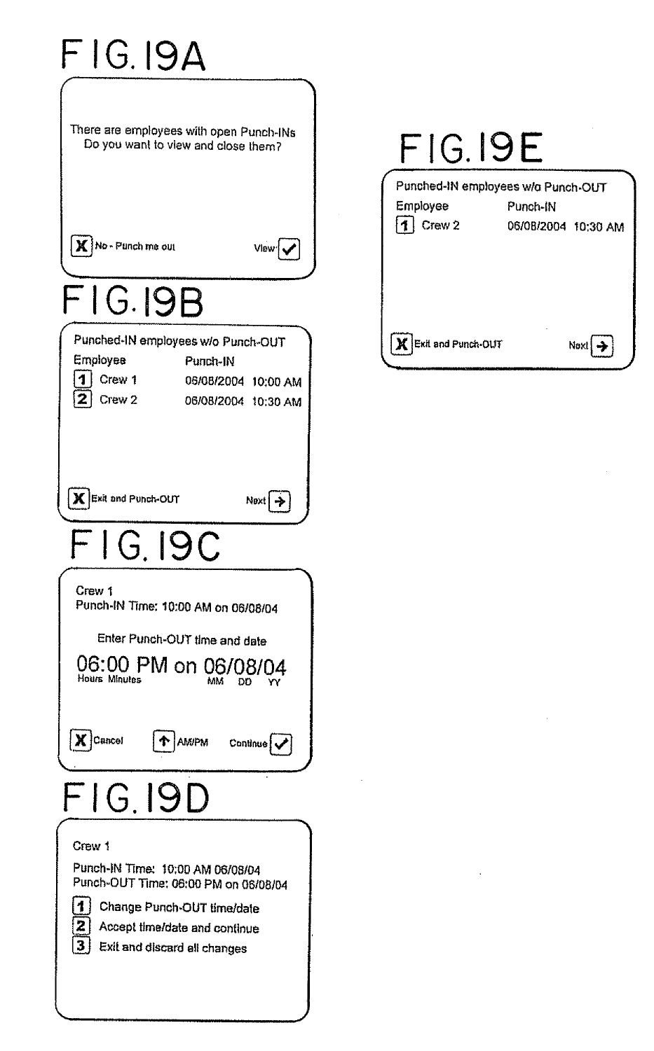

FIGS. 18A-18E illustrate the steps of registering a new employee that is already registered on another site of the APW system. Screens in FIGS. 18A through 18D are the same as in FIGS. 17A-17D and the process is similar up to FIG. 18D. If in FIG. 18D, the “Yes” option is selected, the APW system will search for registration information relating to this new employee at the new site. When the registration information is found, the screen appearing in FIG. 18E will appear requesting whether the supervisor wants to synchronize now or later. In either instance, the registration information for this new employee will be transferred from the site where the information resides to the new work site upon the next synchronization procedure within the APW system.

FIGS. 19A-19E illustrate steps that a supervisor may take to punch-out employees when the supervisor punches out. In FIG. 19A, a supervisor upon punching out will be notified of any employees that have previously punched-in but have not yet punched-out (open punch-ins). In FIG. 19B, those employees that have punched-in are identified with their punch-in times. In FIG. 19C, the supervisor is permitted to enter punch-out times for the employee identified as Crew 1 with the numeric keys on keypad 25. In FIG. 19D, the supervisor can accept the previously entered punch-out time for employee Crew 1. If accepted, the next screen in FIG. 19D identifies the next employee, Crew 2, who has not punched out. The supervisor can then use screens like those in FIGS. 19C and 19D to enter a punch-out time for Crew 2.

FIGS. 20A-20H illustrate steps that a supervisor may take to review and approve of the time records of employees that have missed punch-in or punch-out times and who have voluntarily entered data relating to the missed punches in accordance with the steps discussed above in FIGS. 12A-12F and 13A-13G. When a supervisor is authenticated with the system, he/she will be notified if any missed punches occurred, as in the screen shown in FIG. 20A. The supervisor may elect to immediately continue with the approval process by pressing the numeral 1 key or to approve later by pressing the numeral 2 key in FIG. 20A, which will activate the main menu screen of FIG. 20B. Selection of the administration menu occurs by pressing the numeral 5 key. The administration menu is shown in FIG. 20C, and the numeral 1 key selects the routine for approving missed punches. As seen in FIG. 20D, the missed punches are then identified by time, date and employee. In this example, employee Crew 1 has punched out, but has missed an earlier punch-in. Thus, the supervisor can elect to edit the missed punch-in time by pressing the numeral 1 key, edit the missed punch-in date by pressing the numeral 2 key, or approve the missed punch-in information as entered by the employee.

Pressing of the numeral 1 key in FIG. 20D, the supervisor is advised of the time that the employee entered for the missed punch-in time in FIG. 20E. If the supervisor disagrees with the time entered by the employee, he/she can use the keypad 25 to enter an alternate time of punch-in. The supervisor can also correct the AM/PM time of the day with the up or down arrow keys on the keypad. After entering any corrections to the punch-in time, the supervisor saves the changes by pressing the check key on the keypad. The supervisor may similarly edit the date of the missed punch-in in FIG. 20F. In FIG. 20G, the supervisor can elect to further edit the time or date of the missed punch-in or approve of the edits entered. Pressing of the numeral 3 key will approve the missed punch-in as corrected by the supervisor. The supervisor will then be advised if any more missed punches need to be corrected. When all missed punches are corrected, the screen of FIG. 20H will advise that there are no more missed punches to review, edit or correct.

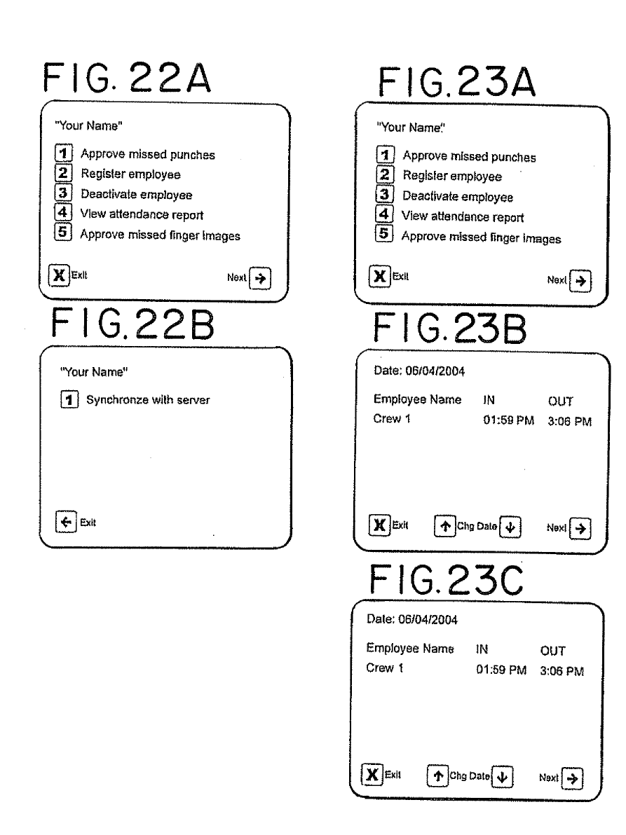

FIGS. 21A-21F relate to the procedure for deactivating an employee. After authentication, a supervisor selects the Deactivate Employee option from the administrative menu of FIG. 21A by pressing the numeral 3 key on keypad 25. In FIG. 21B, the supervisor is prompted to enter the ID number of the employee to be deactivated, which may be the employee's bankcard number, social security number, employee number, or the like. The screen in FIG. 21C then appears requesting the reason for deactivating the identified employee. In this example, the numeral 1 key is pressed to select that the employee quit, rather than was terminated. The screen of FIG. 21D then requests entry of the date of deactivation, which is entered by using the numeral keys on keypad 25. After the accept key is pressed, the supervisor is requested to enter whether the identified employee would be eligible for rehiring in the future, such as on the screen in FIG. 21E. In this instance, the number 2 key is pressed in FIG. 21E to enter that this employee will not be eligible for rehire. When the exit key is pressed, the screen reverts to the supervisory menu of FIG. 21F.

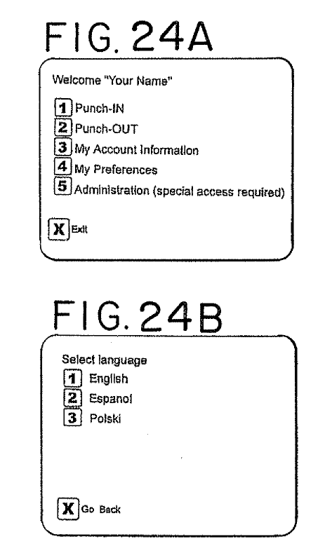

FIGS. 22A-22B illustrate the steps of synchronizing terminal 20 with the APW system. This is required when an additional terminal added to the system, when an existing terminal is replaced or when it is desired to update terminal 20 with the APW system before the next automatic synchronization. Once a terminal is synchronized with the system, it should not normally need to be resynchronized again under normal operating conditions. After the usual authentication procedure, the supervisor sees the administrative screen of FIG. 22A. Since the synchronize option does not appear in the main administrative screen of FIG. 22A, the supervisor selects the next screen with the right arrow key. In the screen of FIG. 22B, synchronize with the server option is selected by pressing the numeral 1 key. Thereafter, the system begins the synchronization procedure with the new terminal 20.

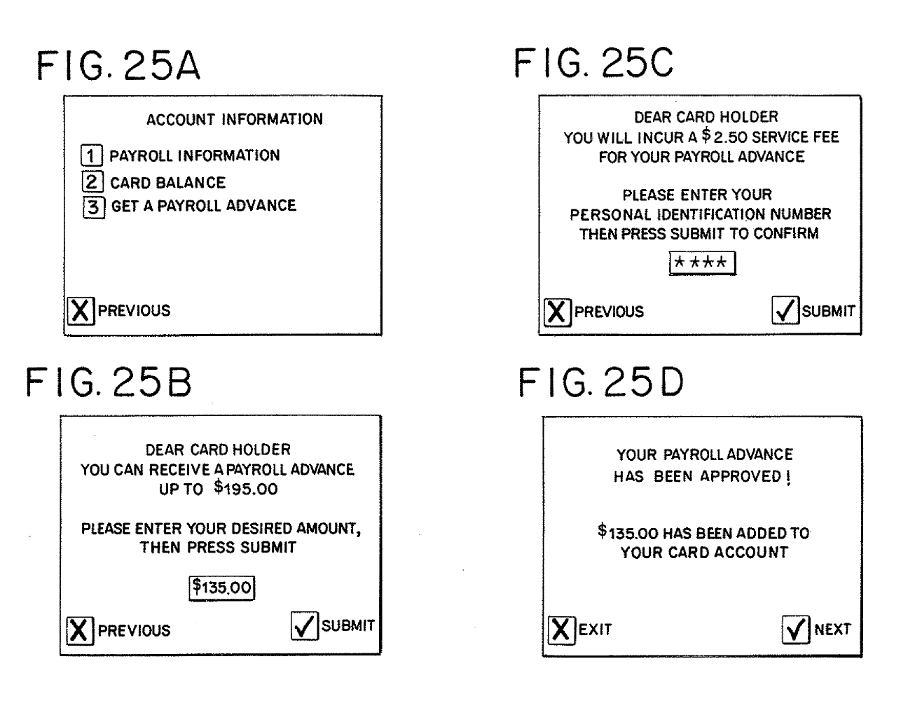

FIGS. 23A-23C illustrate the use of the terminal 20 to view attendance reports by a supervisor. After authentication, the supervisory screen of FIG. 23A appears. The supervisor then elects the View Attendance Report option by pressing the numeral 4 key. The attendance report of the first employee appears in the screen of FIG. 23B. The attendance reports for the same employee, but on other days, can be reviewed by actuating the up or down arrow keys to change the date. To view the attendance records of another employee, the right arrow key is actuated for the next employee. When finishing review of the attendance reports, pressing of the exit key in FIG. 23D returns the supervisor to the main administrative screen of FIG. 23A.

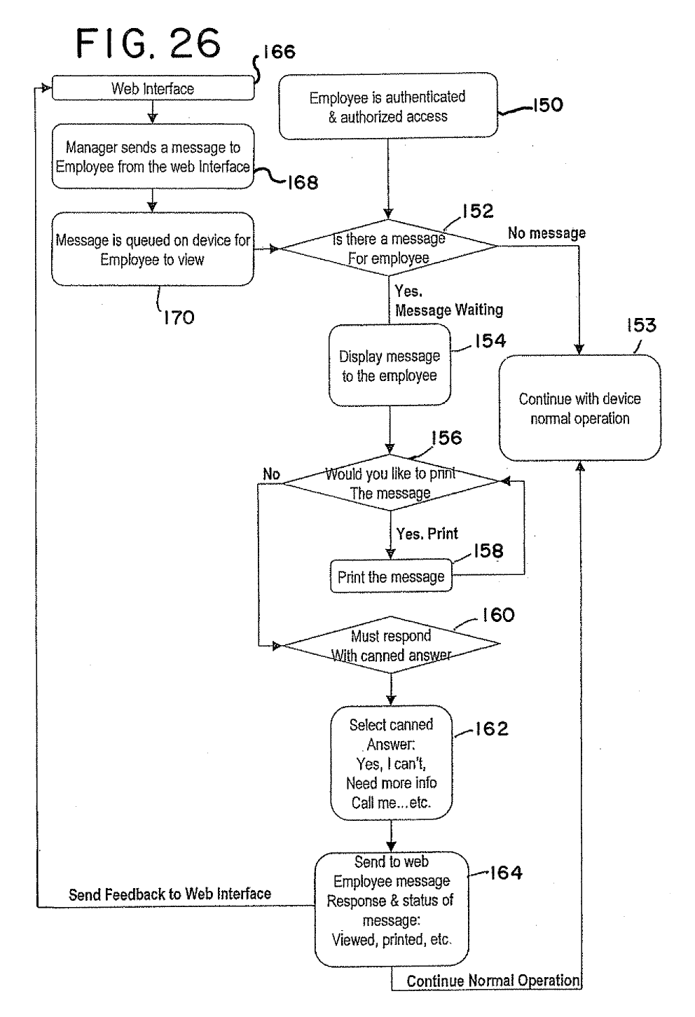

FIGS. 24A-24B illustrate the steps involved in the selection of a desired language after authentication. When presented with the main screen shown in FIG. 24A, the employee may choose to go to My Preferences by pressing the numeral 4 key on keypad 25. The screen in FIG. 24B then permits the employee to choose between the English, Spanish and Polish languages. If English is selected by pressing the numeral 1 key, the menu in FIG. 24A will thereafter be presented in the English language for that employee. The terminal 20 will remember each employee's language preference that is entered as a preference. Otherwise, terminal 20 will use English as the default language. If there is more than one terminal 20 at a site, certain of the terminals may be preset to an alternate language such as Spanish, i.e., Spanish may be the default language for that terminal.

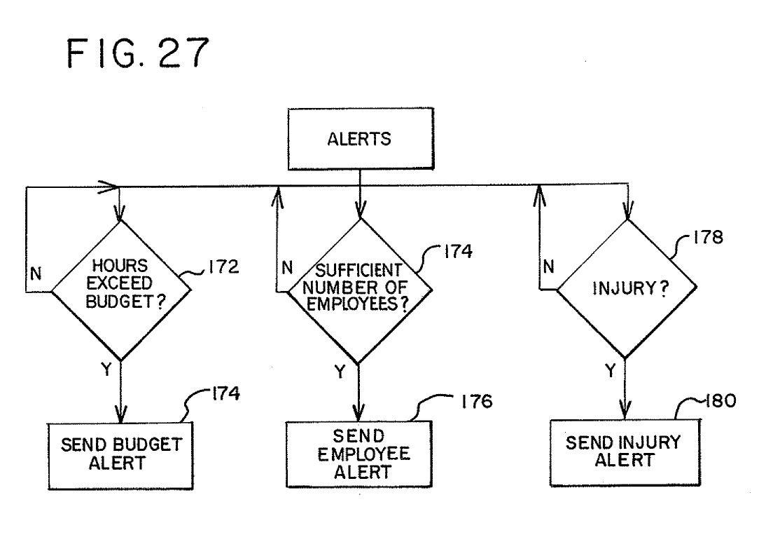

FIGS. 25A-25D illustrate the steps for obtaining a payroll advance against currently accrued pay based upon the hours worked to date. After authenticating and selecting My Account Information on the main screen, the employee may be presented with the options shown in FIG. 25A, including “Get a Payroll Advance”. When this option is selected by pressing the numeral 3 key on keypad 25, the APW system calculates the amount of credit that is available for this particular employee, such as by multiplying the accrued hours worked since the last payday and the employee's hourly compensation rate. This amount is then discounted by a risk factor that includes at least the amount of pay that is deducted for taxes and any other applicable deductions from gross pay. For example, in FIG. 25B, the employee may be notified of the maximum amount of payroll advance that is available. The employee is then prompted to enter the amount of payroll advance that is desired. After pressing the check key to submit the payroll advance request, a screen shown in FIG. 25C may appear advising the employee of service charge applicable to the payroll advance transaction. Some further identification to complete this transaction may also be requested such as a PIN number associated with the employee's bankcard. Upon submitting the PIN, a screen shown in FIG. 25D appears showing that the payroll advance has been approved and that the requested amount has been credited to the employee's bankcard account. The employee may print the screen of FIG. 25D by pressing the print key on keypad 25 (FIG. 9B) or go to the employee's card balance option in FIGS. 16A-16D to confirm that the payroll advance has been credited to his/her account and print the current balance from the screen in FIG. 16D.

A substantial problem in distributed labor management is inability to communicate with field force and inability to get immediate feedback from the work site. The APW system gives managers the ability to log into a secure web page, type a message and select a set of canned answers to be displayed to their remote employees. For example, the manager could write a quick message saying “Joe, please clean aisle 3 immediately after you punch in”, then select (1) “Yes, consider it done”, (2) “Can't”, (3) “I need further detail”, as the canned answers or responses for the work request. The manager would then press a button and the message, plus the canned responses are sent to the appropriate terminal 20. Upon punching-in at his work site, Joe is presented with the message sent from his manager, “Joe, please clean aisle 3 immediately after you punch-in”. He would then respond to the message using one of the 3 three given options: (1) “Yes, consider it done”, (2) “Can't, (3) “I need further detail”. Thus, Joe's supervisor quickly determines whether this additional task will be completed by Joe, or whether additional resources are needed to complete the task.

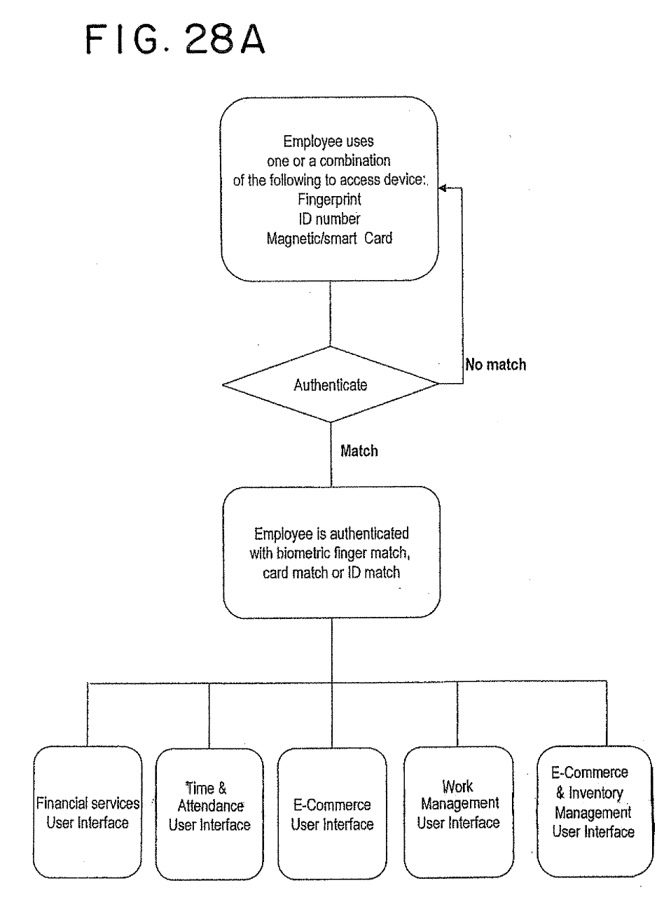

The flow chart in FIG. 26 illustrates these steps in greater detail. A supervisor or manager may create and send a message at block 168, which is then sent to and queued on the terminal 20 that the employee will check-in on, at block 170. After authentication in block 150, if there is a message for the employee (block 152), the message is displayed (block 154). If there is no message at block 152, normal operation of terminal 20 proceeds at block 153. At block 156, the employee is invited to print the message and the message is printed at block 158, if so selected. The process then moves to block 160 which requires a response to the message, such as with canned answers. The employee selects the desired response at block 162, which is then sent via the internet or web to the individual who sent the message; typically a supervisor of the employee. A supervisor or manager may create and send a message at block 168, which is then sent to the terminal that the employee will check-in on, at block 170. The message is then ready for viewing upon authentication at block 152.

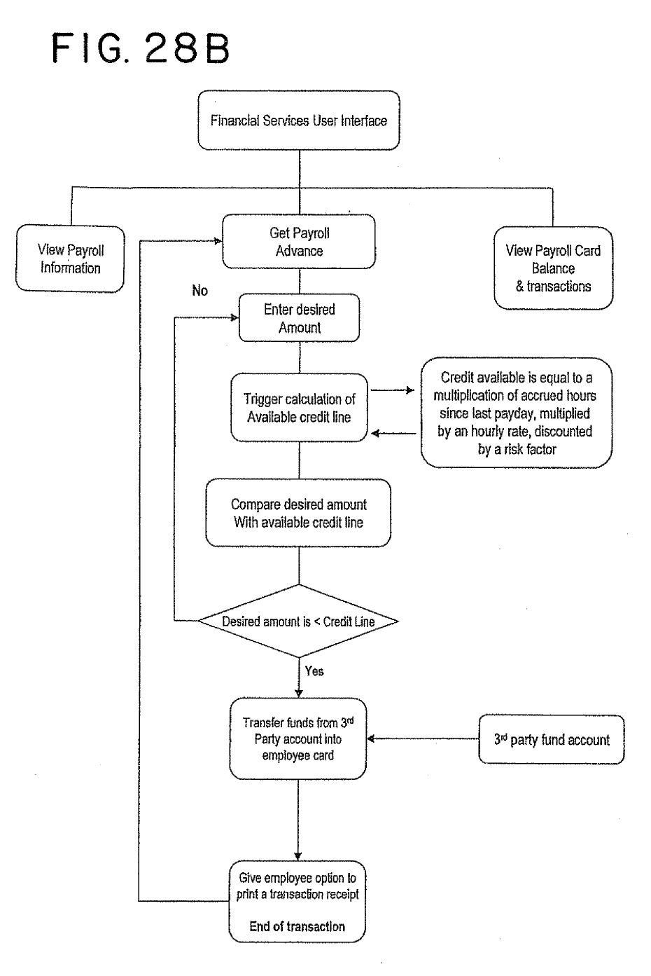

The APW system is also capable of providing a number of different kinds of alerts, such as those shown in FIG. 27. A substantial problem in distributed labor management is inability to manage thousands of employees, their hours and having ability to complete the work within allocated budgeted hours and budgeted dollars. As employees punch-in and punch-out, the system accumulates the amount of hours billed to a specific work location, job code or department code. When the number of hours exceeds a pre-set budgeted hour value (block 172 in FIG. 27), within a specific time-span (such as daily, weekly, bi-weekly or monthly budget), the system automatically alerts a manager or a hierarchy of managers (block 174) notifying them that hours budgeted have been exceeded. The same logic is true if the budgets were an amount in dollars, thus an alert is generated if the dollars spent at the work site, job code or department code have exceeded a budgeted dollar value. Alerts are generated from the local device, then routed via a central system and are delivered to individuals via email, text message, automated fax or automated text to speech synthesizer calling the alert recipient.

Another problem in distributed labor environment is the inability of the service provider to easily manage and track thousands of field employees and make sure that key employees are available and reporting to perform key tasks at customer sites. The system features an ability to notify a single manager or a hierarchy of managers if a single employee, or a set of employees are not present at a work site prior to predetermined time deadline. For example, the system generates an alert notification if a specific employee is not present by 8:00 AM to fix a burnt light bulb. Another example is that the system generates an alert notification if by 8:00 AM, only four out of the expected six cleaning employees are present at the customer's site, such as at block 174 in FIG. 27. Alerts are generated from the local device (block 176), then routed via a central system and are delivered to individuals via email, text message, automated fax or automated text to speech synthesizer calling the alert recipient.

The APW system can also accommodate miscellaneous alerts. For example, these alerts may be generated by an authorized employee using the system from a terminal 20. An authorized employee accesses the system, then uses the user interface at the terminal to initiate an alert, which is then routed to the appropriate manager or hierarchy of managers. For example, on his or her punch-out, the system may ask the employee if he/she had any accident today, such as at block 178 of FIG. 27. If the employee selects “No”, then he/she punches out and no alert issues. If the employee answers “Yes”, then an alert is immediately routed (block 180) to the appropriate manager who may need to investigate the issue further.

A substantial problem in distributed labor management is inability to communicate with field force and inability to get immediate feedback from the work site. The APW system gives managers the ability to log into a secure web page, type a message and select a set of canned answers to be displayed to their remote employees. For example, the manager could write a quick message saying “Joe, please clean aisle 3 immediately after you punch in”, then select (1) “Yes, consider it done”, (2) “Can't”, (3) “I need further detail”, as the canned answers or responses for the work request. The manager would then press a button and the message, plus the canned responses are sent to the appropriate terminal 20. Upon punching-in at his work site, Joe is presented with the message sent from his manager, “Joe, please clean aisle 3 immediately after you punch-in”. He would then respond to the message using one of the 3 three given options: (1) “Yes, consider it done”, (2) “Can't, (3) “I need further detail”. Thus, Joe's supervisor quickly determines whether this additional task will be completed by Joe, or whether additional resources are needed to complete the task.

The flow chart in FIG. 26 illustrates these steps in greater detail. A supervisor or manager may create and send a message at block 168, which is then sent to and queued on the terminal 20 that the employee will check-in on, at block 170. After authentication in block 150, if there is a message for the employee (block 152), the message is displayed (block 154). If there is no message at block 152, normal operation of terminal 20 proceeds at block 153. At block 156, the employee is invited to print the message and the message is printed at block 158, if so selected. The process then moves to block 160 which requires a response to the message, such as with canned answers. The employee selects the desired response at block 162, which is then sent via the internet or web to the individual who sent the message; typically a supervisor of the employee. A supervisor or manager may create and send a message at block 168, which is then sent to the terminal that the employee will check-in on, at block 170. The message is then ready for viewing upon authentication at block 152.

In some of the foregoing examples of the implementation of various functions with terminal 20, the keypad 25 was used to enter the selected choice on the various menus and to navigate from one screen to the next, or the like. Of course, display 21 may be a touch-sensitive display that automatically selects the option that is touched on the screen, rather than requiring entry of an associated key on keypad 25 to initiate the desired function or screen.

FIG. 27 is a flow chart of typical alerts that the system of the present invention may generate upon monitoring the system or upon employee input into the system, and is self-explanatory in view of the foregoing description.

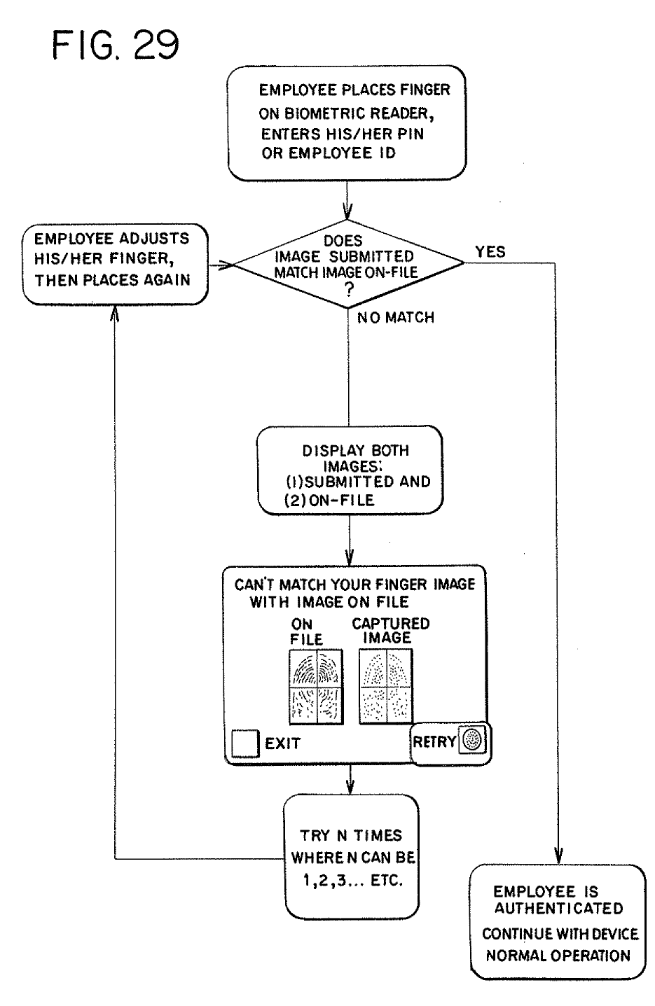

FIGS. 28A and 28B are a flow chart of typical steps involved in calculating and approving a payroll advance, and are self-explanatory.

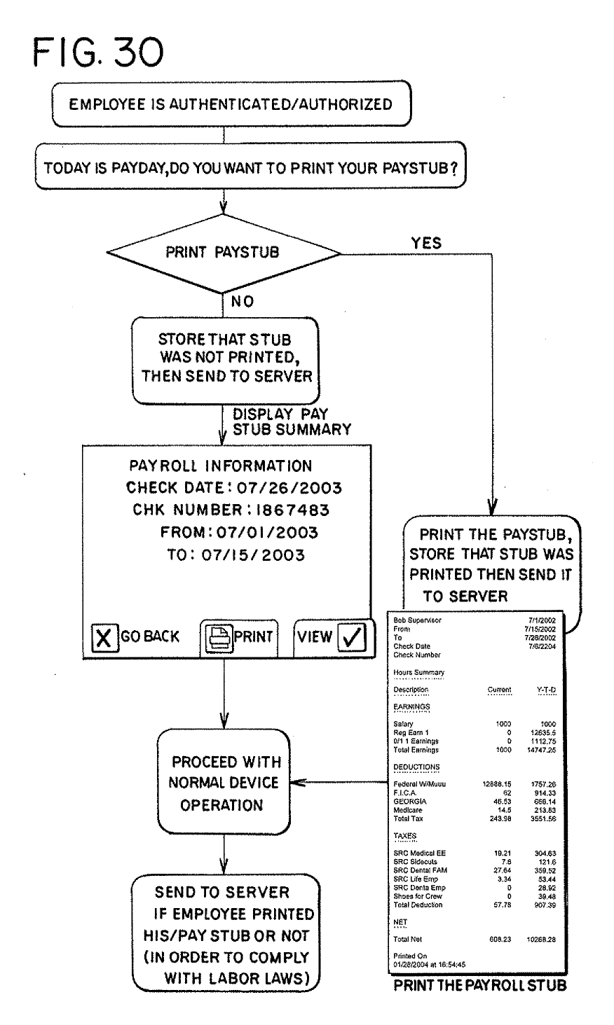

FIG. 29 is a flow chart that provides further detail on authentication with the fingerprint reader, and is self-explanatory.

FIG. 30 is a flow chart providing details of printing a payroll stub from an electronic terminal, and is self-explanatory.

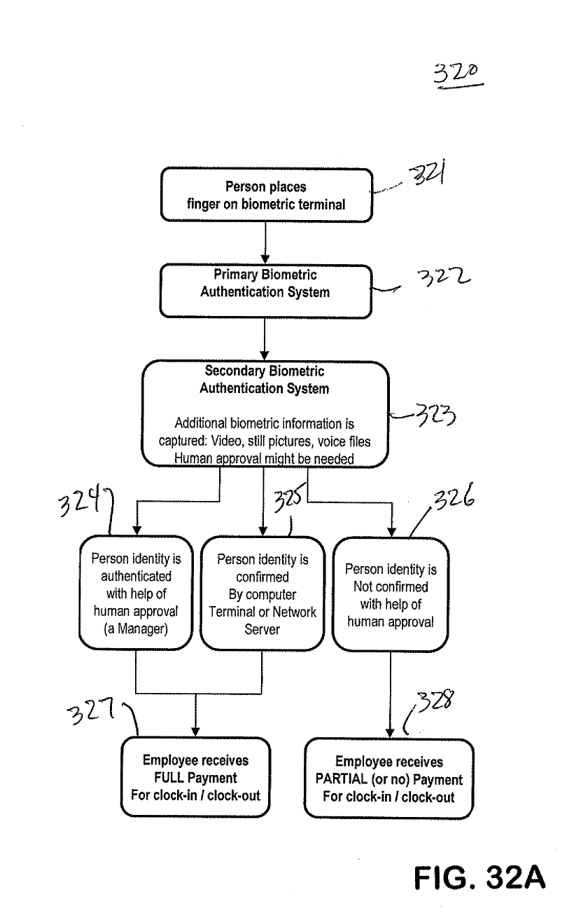

FIG. 31 illustrates a biometric electronic multi-purpose terminal 300 in accordance with the present invention. Like terminal 20 shown in FIGS. 1 and 3, terminal 300 has a screen 21 for displaying information to an employee or other user, including any managers or the like. Terminal 300 also has a fingerprint reader 30 for obtaining data concerning a fingerprint pattern of a person. Terminal 30 may also be equipped with a card reader 22 for reading magnetic data on a bank card, and a keypad for entering numeric information, such as a personal ID (PIN) number, or for navigating through various options displayed on screen 21. As previously shown in FIG. 5 with respect to terminal 20, terminal 300 may also have a modem 45 for accessing the internet 56, a LAN transceiver 32 for communicating with a local area network which may also access the internet, and a wireless transceiver 42 for communicating via an antenna 43 with a remote transceiver 53, such as for a payroll and work management system. Terminal 300 is also preferably equipped with memory 302 for locally storing information, a hard drive 304 for additional data storage, and a plurality of ports, such as USB, serial and PS/2 interfaces 306.

Terminal 300 provides for a second opinion methodology in the event that the primary biometric test, such as with fingerprint reader 30, fails or is inconclusive. To this end, terminal 300 includes a high resolution video camera 310 that captures live video and/or still pictures, and a high resolution microphone 312 which captures person's voice and sound waves. A speaker 314 may be used to direct the person standing in front of the biometric device to follow a set of live or pre-recorded instructions in order to obtain the images with camera 310 or a voice recording with microphone 312.

The system captures additional biometric information from the user standing in front of the biometric terminal, such as video, still picture, and/or voice files. Then, these files are passed on to the local terminal 300, to a networked server, such as to server 101 in FIG. 7, or to a human (local human or remote human) that uses the second set of biometric information to make a (1) match, or (2) no match decision.

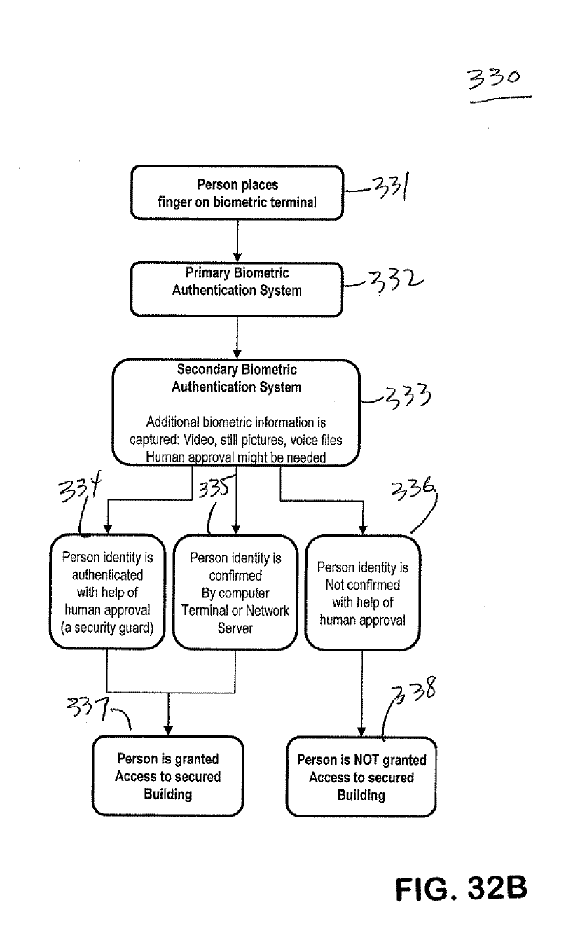

FIGS. 32A and 32B are flowcharts illustrating the steps employed by the electronic terminal 300 shown in FIG. 30 in providing a second opinion to authenticate an employee or to permit a person to have access to a secure building, respectively. In block 321, the person or employee places his/her finger on the fingerprint reader 30 of terminal 300. At block 322, the fingerprint data is gathered as the primary means of authenticating the person. Secondary biometric information is gathered at block 323, such as a video file or picture file via camera 310 or an audio file via microphone 312. If the primary biometric information does not provide a match with corresponding biometric information available in the system, terminal 30 or the system will attempt to obtain a match with the secondary biometric information. If a match occurs with either the primary or secondary information at block 325, the employee receives full payment and is permitted to clock in and clock out at terminal 300.

If no matches occur as a result of the primary or secondary biometric information, a human, such as a manager, may receive a message to review the information available from terminal 300. If approved by the manager at block 324, the employee receives full pay at block 327 and the time of the clock in or clock out is recorded within the system. However, if the human intervention does not confirm identity of the employee at block 326, the employee may receive partial or no pay at block 328 until the discrepancy is resolved. However, the employee may still be allowed to clock in since there may not be a temporary or replacement employee immediately available at the time.

Blocks 331-336 in flowchart 330 of FIG. 32B bear close resemblance to blocks 321-326 in flowchart 320 of FIG. 32B. However, the result of the comparisons of the primary and secondary biometric information is to permit a person to have access to a building at block 337 or not to grant access at block 338.

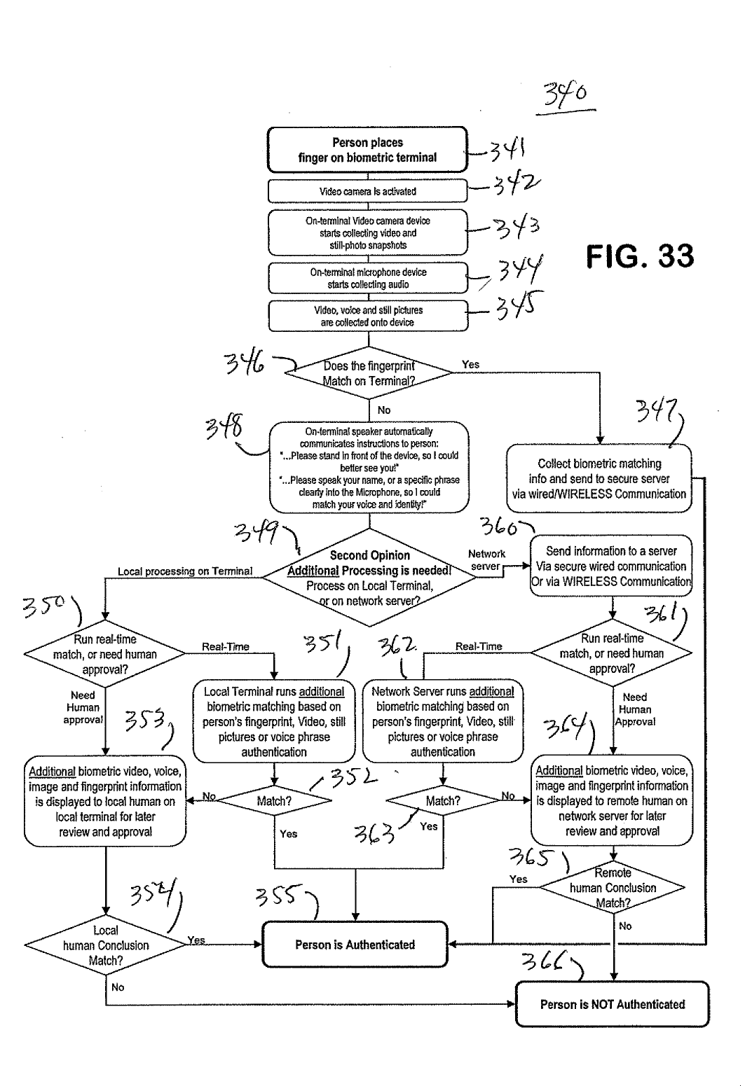

A flowchart 340 in FIG. 33 illustrates in the process of utilizing a secondary type of biometric information to authenticate a person. The process is initiated at block 341 by the person placing a finger on the fingerprint reader 30. At block 342, the video camera 310 may be initiated and a video file and/or a picture file may be collected at block 343. Similarly, the microphone 312 may begin collecting a voice file at block 344. These files may be collected at terminal 300 at block 345. At block 346, a determination is made concerning whether a match is made for the primary type of biometric information. If a match is determined, the matching information may be forwarded by terminal 300 to a server, such as server 101 at block 347 and the person is authenticated at block 355.

If a match was not determined at block 346 on the basis of the primary biometric information, the person may be instructed at block 348 to speak one or more phrases to provide voice files to microphone 312 for further comparison. Block 349 determines if the second opinion relating to comparison of secondary biometric information should occur at terminal 300 or at a network server. This decision may depend upon where the corresponding secondary biometric samples were stored when the employee was register onto the system. If further processing is to occur at terminal 300, block 350 determines whether human intervention is needed. If a determination is made to use the terminal, terminal 350 processes one or more of the secondary biometric information files to determine if there is a match at block 352. If so, the person is authenticated.

If human intervention was required at block 350, the secondary biometric information is reviewed at block 353 by a manager. If a match is determined at block 354, the person is authenticated. Otherwise, if there is not match at block 354, the person is not authenticated at block 366.

If the comparison of secondary biometric information at block 349 determines that further processing should occur at the network server, the process moves to block 360, where the secondary biometric information is sent to the server for review. At the server, the review steps in blocks 361-365 may correspond to the already described review process for blocks 350-354.

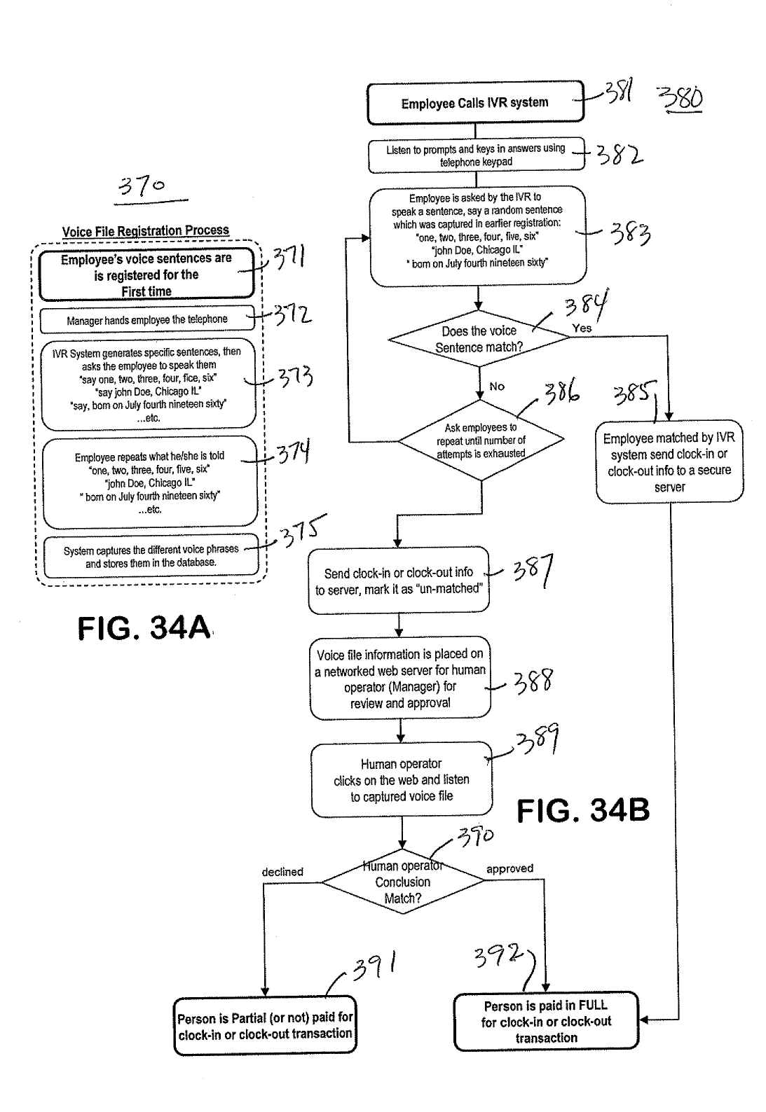

A flowchart 370 in FIG. 34A illustrates typical steps to register a person or employee on an integrated voice response (IVR) system. As explained at starting bubble 371, this involves registering voice sentences or phrases on terminal 300 or server 101 which may be used as samples during comparisons at later times. The employee is given a telephone at block 372. The employee is then asked to speak sample sentences at block 373 which the microphone 312 for recording in terminal 300 or server 101. At block 374, the employee may again be asked to provide additional voice files. At block 375, the system captures and stores these voice files for later use.

FIG. 34B is a flowchart illustrating typical steps which may be employed to remotely authenticate employees in an interactive voice response (IVR) system, with a second opinion provided by human intervention when the IVR system is unable to confirm a match. At starting bubble 381, the employee calls into the IVR system. At block 382, the employee may be asked to provide information from the keypad of the telephone, such as an employee number or a second telephone number. If there is a match with the information entered in block 382, the employee will be asked to speak one or more phrases or sentences which correspond to those used in the registration process of flowchart 370. If there is a voice match at block 385, the employee is authenticated and the person is paid in full at block 392 and the clock in or clock out time is accepted.

If there was not a voice match at block 387, the clock in or clock out time is marked or treated as unmatched at block 387. This requires the intervention of a human or manager to review the voice files at block 388. If the manager determines a match at block 390, the employee is authenticated and the person is paid in full at block 392 and the clock in or clock out time is accepted. However, if there is no match, the person may be paid partially or not at all at block 391. However, the clock in or clock out time may be recorded in the system for later use. Additionally, the employee may be permitted to work since there may be no temporary or backup person immediately available.

While particular embodiments of the invention have been shown and described, it will be apparent to those skilled in the art that changes and modifications may be made therein without departing from the invention in its broader aspects, and, therefore, the aim of the appended claims is to cover all such changes and modifications as fall within the true spirit and scope of the invention.

1. A biometric terminal for authenticating a person, comprising:
a fingerprint reader for reading data relating to a fingerprint pattern of the person,
a microphone for receiving an audio segment from the person,
a speaker for instructing the person to provide an audio segment,
a data processor and a memory for storing the data relating to the fingerprint pattern of the person during a prior registration of the person on the terminal and for storing an audio segment of the person during a prior registration of the person on the terminal, said data processor comparing current data of the fingerprint pattern to the prior stored data to determine if the current data is a match with the stored data,
if there is not a match of the data relating to the fingerprint, the terminal activates the speaker to instruct the person to provide an audio segment,
the microphone receives the audio segment, and
the data processor determines if the current audio segment from the microphone matches the prior stored audio segment.

2. A biometric terminal for authenticating a person, comprising:
a fingerprint reader for reading data relating to a fingerprint pattern of the person,
a camera for receiving a video clip or a still picture from the person,
a data processor and a memory for storing the data relating to the fingerprint pattern of the person during a prior registration of the person on the terminal and for storing a video clip or a still picture of the person during a prior registration of the person on the terminal, said data processor comparing current data of the fingerprint pattern to the prior stored data to determine if the current data is a match with the stored data,
if there is not a match of the data relating to the fingerprint, the terminal activates the camera to take a video clip or a still picture of the person, and
the data processor determines if the current video clip or still picture of the person matches the prior stored video clip or a still picture.
